(19) United States
(12) Patent Application Publication
(10) Pub. No.: US 2018/0111538 A1
(43) Pub. Date: Apr. 26, 2018

(54) SYSTEM, APPARATUS AND METHOD FOR MONITORING AND DELIVERY OF SALT

(71) Applicant: Saltco, LLC, Prairie du Sac, WI (US)

(72) Inventors: Craig Detter, Waunakee, WI (US); Theodore R. Gerry, Merrimac, WI (US)

(21) Appl. No.: 15/791,873

(22) Filed: Oct. 24, 2017

Related U.S. Application Data
(60) Provisional application No. 62/413,094, filed on Oct. 26, 2016.
(60) Provisional application No. 62/470,014, filed on Mar. 10, 2017.
(60) Provisional application No. 62/541,520, filed on Aug. 4, 2017.

(51) Int. Cl. B60P 1/42

(52) U.S. Cl. CPC B60P 1/42; C02F 1/42

(57) ABSTRACT

A salt delivery system for remotely delivering water softening salt from a salt source outside a structure to a brine tank or salt bin located inside the structure. The salt delivery system includes a fluid moving apparatus that creates a positive pressure in the system for moving salt from the salt source into the brine tank while also creating a nominal or negative pressure inside the brine tank. The salt delivery system brine tank also includes one or more sensors to provide near real-time monitoring of salt levels in the tank.

### CROSS-REFERENCE TO RELATED APPLICATIONS

This application claims priority to U.S. Provisional Application Nos. 62/413,094 filed Oct. 26, 2016; 62/470,014 filed Mar. 10, 2017; and 62/541,520 filed Aug. 4, 2017, each entitled “System, Apparatus and Method for Monitoring and Delivery of Salt,” the contents of which are hereby incorporated by reference in their entireties.

### FIELD

The present inventions relate to the field of the delivery of salt and other granular material to storage containers and bins. The present inventions more specifically relate to the field of residential and commercial delivery of water-softening salt to brine tanks.

### BACKGROUND

It is known to use water softeners in residences and businesses to soften and/or condition hard water. Many water softening systems help soften the water by replacing minerals such as iron, calcium, and magnesium with sodium ions. Typically, salt is used to provide these sodium ions, and the salt is normally kept in a brine tank, storage container or bin. The brine tank may be adjacent to the water softener in the interior of the residence or business, or located outside the building.

The salt used in a water softening process can take many forms, including solar salt and salt pellets. The salt is commonly sold in bags of various sizes. These bags tend to be heavy (e.g., 40-50 pounds), awkward and tedious for a person who must transport them from the place of sale or purchase to the brine tank, open them up, and lift them and empty the contents into the tank. Because bagged salt is tedious and difficult for many people to lift, carry, and empty into a brine tank, brine tanks are typically no taller than waist height and do not optimize the use of available space (e.g., above the tank).

While there are delivery services and personnel who will deliver bags of salt and carry and empty them inside the residence or business, the home or business owner typically prefers to or is required to be present at the time of delivery and provide the personnel with entry into the building. Home and business owners are naturally reluctant to simply provide the service personnel access to their premises without being present. This delivery process can be inconvenient to the home and business owner. For a business owner having a brine tank, this can be a wasteful labor situation in terms of monitoring tanks, filling tanks, picking up salt, managing deliveries and storage of salt and, more importantly, can create potential risks associated with lifting heavy bags off the floor and/or emptying them into a brine tank. Serious bodily injuries can occur, such as but not limited to injury of the lower back, shoulders and neck areas. Also, most businesses, being security conscious, now have escorts for delivery personnel, increasing the cost to the business to escort the delivery person to and from the brine tank. In addition, the cost of leasable space to store salt for a business owner can be very expensive. For example, the typical area needed to store a full pallet of salt is approximately seven feet by seven feet, or forty-nine square feet, and this is space that could be used for other things. In addition, the process of replacing or refilling salt in the brine tank can be messy as it produces salt dust. And, the use of salt bags results in the creation and likely waste of thousands of non-biodegradable bags annually.

There are salt delivery services and systems that operate to remotely deliver water-softening salt from a vehicle outside a structure to a salt bin or brine tank located inside the structure. Consider, for example, U.S. Pat. No. 9,475,528, entitled “System and Method for Delivery of Salt,” in the name of Stepsaver, Inc., the entirety of which is incorporated herein by reference.

Such delivery systems have a number of disadvantages, are not optimized for salt delivery, and need improvement. For example, the pressure in such a delivery system must be monitored to know when to turn off salt delivery. In addition, the salt remaining in a fill tube and lines leading to that tube must be recovered or at least removed. As more specifically indicated in U.S. Pat. No. 9,475,528, such known systems require “reversing a direction of the air pressure to reclaim salt in the salt delivery hose to the recovery tank; and determining a weight of the salt after delivery using a computerized scale system.”

Such salt recovery systems and recovery time add expense and delay to the delivery and filling process. For example, a delivery agent may need to uncouple the fill tube connected to the salt output of a truck and reconnect it to a vacuum tube of the truck that is part of the recovery system. Such known systems also require an extra step of weighing recovered salt to accurately determine weight or amount of delivered salt.

Such salt recovery may also require a separate weighing system. Alternatively, if it uses the same system for weighing and determining salt recovered that it used for weighing and determining salt output, such known systems may also contaminate the salt on the truck. For example, as the salt in the tube is vacuumed back into the truck, it is exposed to air, moisture, humidity, and/or contaminants also being drawn into the tube during the salt recovery process.

Known systems are also disadvantageous in that they allow contamination of a house during delivery. For example, while some known systems, such as the system disclosed in U.S. Pat. No. 9,475,528, disclose the use of a canvas brine tank cover or filter to help capture or contain unwanted materials or contaminants such as salt dust, such covers do not appear to contain all salt dust due to imperfections in the filters and seals (e.g., around the edges or perimeter of the brine tank). Further, these imperfections in filters can be made worse by the fact that the filter tends to inflate and deflate during a filling process, and this inflation and deflation and other movement tends to allow or promote the unwanted escape or distribution of salt dust.

In addition, such known systems introduce outside air into the interior of building or residence. For example, some outside air, humidity, and/or allergens may pass through the cover or filter during the fill process. Such allergens are undesirable. Further, such air is not conditioned to match ambient air in the building or residence. For example, in the summer, the introduced air is likely hotter than the ambient internal air temperature and, in the winter, the introduced air is likely colder than the ambient internal air temperature. Regardless of season, introduced air also forces or exhausts air or other gases that were in the tank into the internal environment.

In addition, known systems such as the system disclosed in U.S. Pat. No. 9,475,528 teach the use of commercial or semi-trucks to deliver salt. Such trucks are typically difficult to navigate on residential streets, generally not allowable on most such streets due to overweight rules, and difficult get near and/or park on residential driveways, alleys, etc., which makes it difficult to access many residentially located brine tanks. Further, such trucks may require a commercial driver's license (CDL) thereby limiting the pool of potential drivers. Such trucks, compared to other vehicles, use relatively more fuel, cause increased noise pollution, have a relatively larger carbon footprint, and cause relatively more wear and tear on highways, city streets, and driveways.

Known systems such as the system disclosed in U.S. Pat. No. 9,475,528 further require existing brine tanks be replaced with commercial grade tanks which can be wasteful and add expense to the process. Further, such tanks tend to have relatively larger footprints than conventional residential tanks and therefore require more square footage or room in the building.

Also, known systems such as the system disclosed in U.S. Pat. No. 9,475,528 have no monitoring system and instead rely on guesswork or manual monitoring in determining salt usage and need. In many cases, the salt refill service provider is guessing at the salt level usage. Therefore, following a delivery, a brine tank will frequently not have the optimal amount of salt. If excess salt is delivered, the service provider may incur unnecessary costs in coming to the residence too early for the next delivery. When the need for salt goes too long, and the brine tank goes past or below the desired refill range, a customer risks water hardness and lime buildup, possible damage to their water systems, and, more importantly, a shortened life span for its water-based appliances (e.g., hot water heaters, plumbing fixtures, valves and equipment). In addition, human hygiene is affected as a result of hard water on skin and hair.

### SUMMARY

There is a need for, and it would be desirable to provide, an improved system and method for salt delivery. For example, there is a need for a system that does not require active pressure monitoring, switching hoses or additional delivery steps, effort, systems and time for recovery of excess delivered salt. There is a need for a delivery system that can reach more brine tanks more quickly and easily. There is also a need for a more closed system that reduces salt contamination and internal air contamination compared to known systems. There is also a need for a salt delivery vehicle that is or can be more compact and does not require a CDL. There is also a need for a “greener” solution, a solution that conserves fuel, reduces noise pollution, reduces carbon footprint, reduces wear and tear on highways and city streets, lowers fuel costs, reduces costs (e.g., to the consumer), and/or is otherwise more economical. There is also a need for a system that can be retrofit to an existing tank and/or that can use a replacement tank having the same, substantially similar or even relatively smaller base footprint as a tank already in the residence or building. There is also a need for a taller tank that can hold more salt and likely require less frequent refilling of salt. There is also a need for a tank whose salt levels can be monitored remotely such that delivery may take place at or around the optimal filling time based on factors such as salt usage and current salt level in the tank, while even optimizing the cost of delivery through a comprehensive route plan. There is also a need for a single delivery operator/driver instead of the typical two operators as used in most commercial delivery operations which would benefit staffing costs.

Accordingly, an improved system, apparatus and method for delivery of salt are provided. The present disclosure provides a number of advantages over known salt delivery systems. For example, the salt delivery system disclosed is mobile and/or portable and can be transported by vehicle to a location needing salt. Further, the process may be accomplished without need for anyone to enter a residence or business, or having the homeowner take time to meet a delivery person, or business owner having to deploy property management services to handle deliveries and loading. In addition, the salt may be loaded and provided without the use of heavy salt bags which reduces the cost of the salt as it can be purchased and sold in bulk form and eliminates the need for bags and other packaging. In addition, the rotary valve and fluid moving apparatus disclosed herein allows a relatively steady form of fluid flow that should not be obstructed by other components and produces the amount of force necessary or desired to propel or convey salt from the vehicle to the brine tank, salt bin or storage container.

Accordingly, a system and method for delivering salt and related materials is disclosed, comprising, according to various embodiments, a delivery system including a delivery truck having a fluid moving apparatus connected or coupled to a delivery hose connected or coupled to a piping system, connected or coupled to a tank having a system to monitor salt depth, and brine tank status, connected or coupled to a return pipeline, conduit or outlet for helping create and/or maintain a level or range of vacuum bias and maintain negative pressure within the tank during salt delivery.

Accordingly, a salt delivery system is disclosed, the system comprising: a mixing tube in fluid communication with an outlet of a fluid moving apparatus; a salt source in operative communication with the mixing tube; a delivery hose in fluid communication with the mixing tube and a fill port on a structure; a first conduit in fluid communication with the fill port and an inlet of a brine tank; a second conduit in fluid communication with a return outlet of the brine tank and a return port on the structure; and a return hose in fluid communication with the return port and an inlet of the fluid moving apparatus.

Accordingly, a salt delivery system is also disclosed, the salt delivery system comprising a substantially closed loop extending from an outlet of a fluid moving apparatus to an inlet of a brine tank and from an outlet of a brine tank back to an inlet of the fluid moving apparatus.

Accordingly, a method for delivering salt into a brine tank is disclosed, the method comprising: transporting a vehicle having a salt source, a rotary valve, and a fluid moving apparatus having an outlet and an inlet, to a location near a structure housing a brine tank, the brine tank having an inlet fluidly connected to a fill port on the structure and an outlet fluidly connected to a return port on the structure; fluidly coupling the outlet of the fluid moving apparatus to the fill port using a delivery conduit; fluidly coupling the inlet of the fluid moving apparatus to the return port using a return conduit; rotating the rotary valve to introduce salt from the salt source into the delivery conduit; and operating the fluid moving apparatus to create positive pressure to move salt through the delivery conduit and the fill port and into the brine tank while simultaneously creating a nominal or negative pressure in the brine tank and return conduit

### BRIEF DESCRIPTION OF DRAWINGS

Various examples of embodiments of the systems, devices, and methods according to this invention will be described in detail, with reference to the following figures, wherein:

FIG. 1 illustrates a schematic diagram of a salt delivery system, including an on-site system, a transportable system, and an administrative system, according to various examples of embodiments;

FIG. 2 illustrates a schematic diagram of various components of an on-site system and portable system of a salt delivery system, according to various examples of embodiments;

FIG. 3 illustrates a partial isometric view of a brine tank lid or top helping illustrate airflow into a brine tank during salt delivery, according to various examples of embodiments;

FIG. 4 illustrates a perspective view of a brine tank lid with inlet, outlet and sensor housing, according to various examples of embodiments;

FIG. 5 illustrates a perspective side view of an inlet/outlet for a brine tank, according to various examples of embodiments;

FIG. 6 illustrates a perspective bottom view of the inlet/outlet for a brine tank illustrated in FIG. 5;

FIG. 7 illustrates a perspective side view of a sensor housing, according to various examples of embodiments;

FIG. 8 illustrates a perspective side view of a sensor housing, according to various examples of embodiments;

FIG. 9 illustrates a perspective top view of component parts of the sensor housing illustrated in FIG. 8;

FIG. 10 illustrates a side perspective exploded view of a sensor module and the sensor housing illustrated in FIG. 8;

FIG. 11 illustrates a cross-sectional schematic view of a sensor module and a sensor housing, according to various examples of embodiments;

FIG. 12 illustrates a top perspective view of the sensor housing illustrated in FIG. 8 with a first indicator visible, according to various examples of embodiments;

FIG. 13 illustrates a top perspective view of the sensor housing illustrated in FIG. 8 with a second indicator visible, according to various examples of embodiments;

FIG. 14 illustrates a schematic diagram of a sensor module or circuit board, according to various examples of embodiments;

FIG. 15 illustrates a bottom view of a sensor module or circuit board, according to various examples of embodiments;

FIG. 16 illustrates a top view of the sensor module or circuit board illustrated in FIG. 15, according to various examples of embodiments;

FIG. 17 illustrates a schematic diagram of a sensor module or circuit board, according to various examples of embodiments;

FIG. 18 illustrates a schematic diagram of a Power-Over-Ethernet (POE) cable, according to various examples of embodiments;

FIG. 19 illustrates a schematic diagram of a network interface module (NIM) including a particle.io single board computer and RJ45 jack, according to various examples of embodiments;

FIG. 20 illustrates a schematic diagram of a transportable system of a salt delivery system, according to various examples of embodiments;

FIG. 21 illustrates a partial perspective view of a hopper of a transportable system, according to various examples of embodiments;

FIG. 22 illustrates an isometric view of an auger extending into a hopper of a transportable system, according to various examples of embodiments;

FIG. 23 illustrates a partial perspective view including an auger and transfer box of a transportable system, according to various examples of embodiments;

FIG. 24 illustrates a partial perspective view of an auger and transfer box of a transportable system illustrating the provision of salt into a rotary valve of a transportable system, according to various examples of embodiments;

FIG. 25 illustrates a partial perspective view of an auger, transfer box and rotary valve of a transportable system illustrating the provision of salt into a rotary valve of a transportable system, according to various examples of embodiments;

FIG. 26 illustrates a schematic diagram of a rotary airlock valve of a transportable system, according to various examples of embodiments;

FIG. 27 illustrates a perspective view of a fluid moving apparatus (e.g., positive displacement pump) for use in connection with a portable system of a salt delivery system, according to various examples of embodiments;

FIG. 28 illustrates a schematic view of a positive displacement pump, according to various examples of embodiments;

FIG. 29 illustrates a perspective view of hoses and hose connection for a transportable system of a salt delivery system, according to various examples of embodiments;

FIG. 30 illustrates a perspective view of hoses and hose connections for a transportable system of a salt delivery system, according to various examples of embodiments;

FIG. 31 illustrates a schematic diagram of an administration system of a salt delivery system, according to various examples of embodiments;

FIG. 32 illustrates a schematic diagram of an administration system of a salt delivery system, according to various examples of embodiments.

FIG. 33 illustrates a schematic diagram of an administration system of a salt delivery system, according to various examples of embodiments.

FIG. 34 illustrates a schematic diagram of an administration system of a salt delivery system, according to various examples of embodiments.

FIG. 35 illustrates a schematic diagram of system architecture for an administration system of a salt delivery system, according to various examples of embodiments;

FIG. 36 illustrates a diagram of a tree structure of a non-SQL database of an administration system, according to various examples of embodiments;

FIG. 37 illustrates a schematic diagram of a data model of customer data management system of an administration system, according to various examples of embodiments;

FIG. 38 illustrates a schematic diagram of a data model of fleet management system of an administration system, according to various examples of embodiments;

FIG. 39 illustrates a sequence or process diagram for a method for salt monitoring and delivery, according to various examples of embodiments;

FIG. 40 illustrates a network interface module state diagram, according to various examples of embodiments;

FIG. 41 illustrates a user interface of an administration system of a salt delivery system, according to various examples of embodiments;

FIG. 42 illustrates a user interface of an administration system of a salt delivery system, according to various examples of embodiments;

FIG. 43 illustrates a user interface of an administration system of a salt delivery system, according to various examples of embodiments;

FIG. 44 illustrates a process diagram for delivery determination, according to various examples of embodiments;

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

A system, apparatus, and method for (remotely) monitoring and delivering salt (e.g., from a vehicle outside a structure (such as a commercial or residential building)) to a salt bin or brine tank typically located inside the structure are provided.

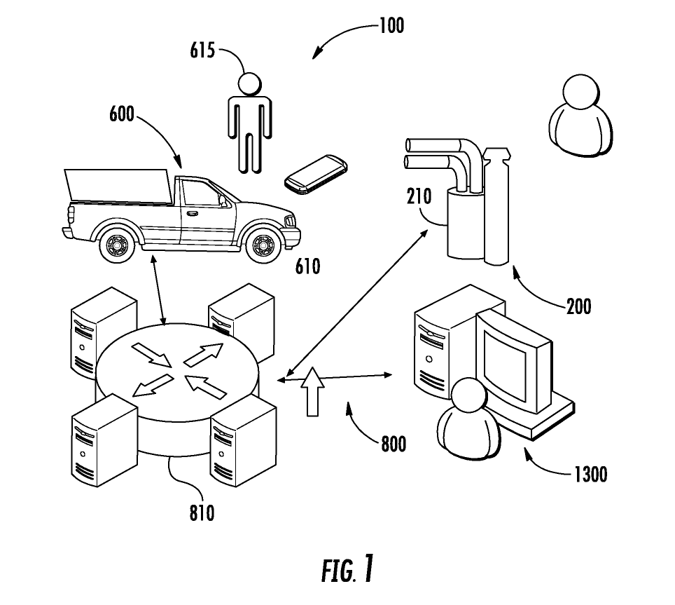

Referring now to FIG. 1, a salt delivery system 100 is illustrated, according to various examples of embodiments. In various embodiments, salt delivery system 100 includes an on-site system 200 including a brine tank 210 for receiving and temporarily holding salt. In various embodiments, salt delivery system 100 also includes a transportable system 600, which may include a salt delivery apparatus or vehicle 610, such as a customized delivery truck for delivering salt to the on-site system.

In various embodiments, salt delivery system 100 also includes an administration system 800 including one or more networks and/or servers 810 (e.g., cloud servers) in communication with one or more components of on-site system 200 for receiving and retaining salt, one or more components associated with transportable system 600 (which may include one or more mobile communication tools available to a delivery agent 615), and/or an off-site or remote location 1300 such as a business office.

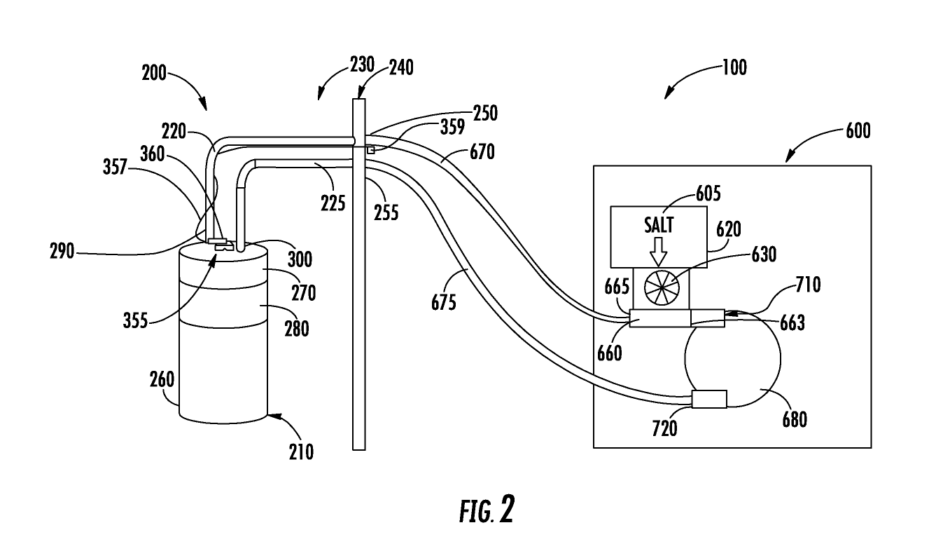

Referring now to FIG. 2, salt delivery system 100 including on-site system 200 and transportable system 600 is illustrated. In various embodiments, on-site system 200 includes brine tank 210 coupled (e.g., fluidly coupled) to an inlet conduit 220 and an outlet conduit 225. In various embodiments, brine tank 210 of on-site system 200 is located on a premises 230, in a structure 240 such as a house or other building, and inlet conduit 220 extends from brine tank 210 to an inlet or fill port 250, and outlet conduit 225 extends from brine tank 210 to an outlet or exhaust or return port 255, located outside structure 240.

In various embodiments, brine tank 210 includes a base 260 and a top or lid 270. In various embodiments, brine tank 210 is taller than known brine tank bases. For example, brine tank 210 of on-site system 200 is typically at least sixty-three inches tall but it may be as tall as seventy-three inches tall or taller. In various embodiments, brine tank 210 footprint is similar to known tanks. The height of brine tank 210, which is not necessary or required to be limited to waist height (due to the elimination of a need to provide salt into brine tank 210 from a bag), allows brine tank 210 to have more capacity to hold salt than a standard tank, without changing the existing or typical brine tank 210 footprint. In various embodiments, brine tank 210 and/or its components are grounded electrically to premises 230 and/or ground to dissipate static charge build-up which may occur during a fill process.

Use of a taller/larger brine tank 210 than that typically used may help to reduce the number of deliveries required over time. Reduction in deliveries may significantly reduce the carbon footprint through reduction of consumption of diesel fuel, carbon monoxide output, traffic pollution and road access in dense metropolitan areas, wear and tear on highways and city streets, noise pollution in business districts and residential zones. Reduction in deliveries also reduces cost per fill to the business and therefore consumer costs.

In various embodiments, on-site system 200 includes a tank adapter or hood 280 that may, for example, be retrofit to an existing brine tank 210 or brine tank base 260. In various embodiments, tank adapter or hood 280 may be coupled to a top of an existing tank base 260. In various embodiments, tank adapter or hood 280 allows the height and capacity of existing tank 210 to increase while maintaining the existing tank footprint.

Referring now to FIGS. 2 and 3, in various embodiments, tank top or lid 270 includes or is coupled to an inflow or salt inlet 290 in fluid communication with fill port 250. In various embodiments, tank top or lid 270 also includes or is coupled to an outflow or exhaust or return outlet 300 in fluid communication with exhaust return on port 255. In various embodiments, salt inlet 290 and exhaust outlet 300 are sealed to tank lid or top 270. In various embodiments, tank lid or top 270 is at least substantially sealed to tank base 260 or adapter or hood 280.

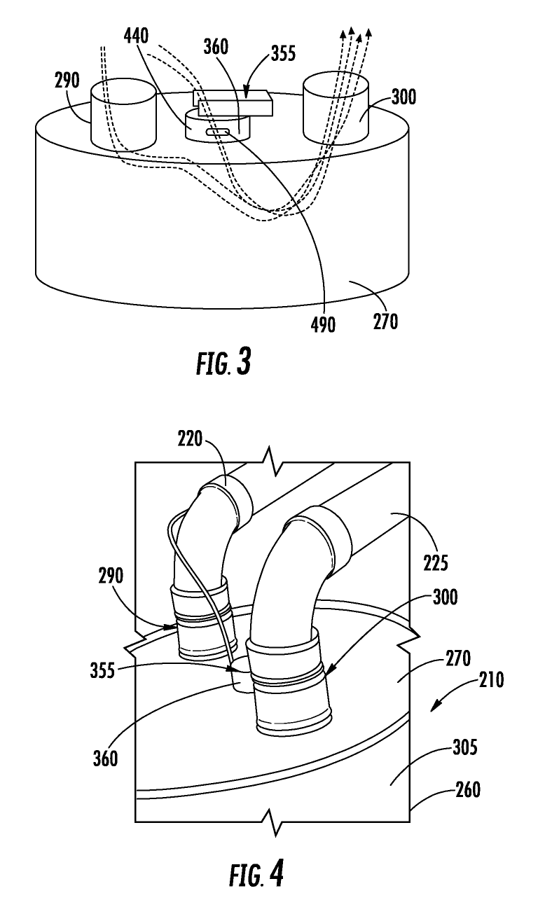

In various embodiments, and referring now to FIG. 4, tank lid 270 includes and/or is coupled to tank base 260, adapter hood 280, and/or tank inlet/outlet 290/300, e.g., using known components. In various embodiments, a combination of known pipes, couplers, connectors, and sealant tape are used in coupling and/or sealing lid 270 to adapter 280 or base 260, and in coupling and/or sealing inflow or inlet 290, outflow or outlet 300, and conduits 220/225, which helps minimize cost and installation complexity while meeting the need for a substantially airtight sealed system. For example, as shown in FIG. 4, an adhesive tape 305 such as duct tape or other known tape such as Proselect brand tape from Ferguson Enterprises, Inc. is used to couple and/or substantially seal brine tank lid 270 to brine tank base 260 or an adapter.

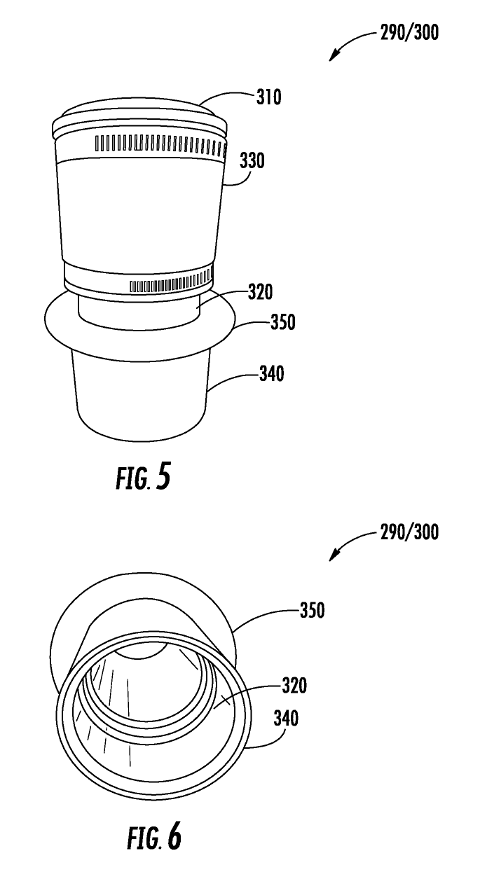

In various embodiments, and referring now to FIGS. 5-6, brine tank inflow or salt inlet 290 and/or a brine tank outflow or exhaust air or pressure output 300 include a first pipe 310 (e.g., a standard three-inch diameter PVC Schedule 40 pipe) leading into and/or coupled to a second pipe 320 using a first coupling 330 (e.g., a Fernco brand coupling with standard stainless hose clamps). In various embodiments, the length of second pipe 320 is only about two to three inches so that it protrudes about one inch into a second coupling 340 (e.g., a standard three-inch diameter Schedule 40 PVC female to female coupling) below the tank lid and about one inch into the first coupling 330 above the tank lid. In various embodiments, the tank lid surrounds the inlet and/or outlet around a portion of second pipe 320. That is, in various embodiments, second pipe 320 is sufficient in length to extend into second coupling 340 and extend about an inch into the first coupling 330. In various embodiments, a washer 350 (e.g., rubber washer) is provided around second pipe 320 and, when in position relative to the tank lid, mounted below the tank lid.

It should also be appreciated, however, that the inlet and/or outlet may also or instead be integral to (e.g., molded into) the tank lid.

Referring again to FIG. 4, in various embodiments, an end of salt inlet 290 and/or second coupling 340 extends inside brine tank 210. In various embodiments, the end of salt inlet 290 and/or second coupling 340 is provided at a distance or level below tank lid 270 and into tank 210 corresponding generally with a level below the top level of the salt in tank 210 when tank 210 is filled to capacity with salt (e.g., approximately two inches from or below the tank lid).

In various embodiments, as the salt fill level reaches the end of salt inlet 290 and/or second coupling 340 inside the brine tank, the salt may stop or slow the flow of salt by essentially clogging the end of salt inlet 290 and/or second coupling 340 and prevent the salt delivery system 100 from being able to blow salt at sufficient pressure into the tank to help prevent overflow.

In various embodiments, a cyclonic separator (not shown) is provided above the salt inlet to absorb air pressure, while allowing separation of air and salt (e.g., with air to exit the exhaust tube, while salt drops into the relatively less pressurized or unpressurized salt tank which may be assisted by a rotary valve or butterfly valve added below the cyclonic separator to help contain the pressure). The use of a cyclonic separator and cyclonic separation are helpful for separating product from the force that is applied to move it. In various embodiments, the use of a cyclonic separator and/or cyclonic separation helps reduce the amount of pressure the tanks need to withstand in order to maintain an air-tight seal, and prevents dust or particles in the residence or building. In addition, the amount of dust may be reduced, as the tangential line the product arrives on reduces its speed over a greater distance, versus being immediately stopped by the level of the salt in the tank.

Referring again to FIG. 2, in various embodiments, inlet conduit 220 and outlet conduit 225 couple (e.g., fluidly couple) inlet 290 and outlet 300 to fill port 250 and an exhaust port 255, respectively. In various embodiments, conduits 220/225 are sealed to help create a pressurized or pressurizable (e.g., negatively pressurized or pressurizable) system during a filling process but help eliminate air or dust leaks into structure 240 or premises 230. In various embodiments, long sweep elbows help fluidly connect or couple the one or more pipes or conduits to reduce turbulence and friction.

In various embodiments (e.g., those using a closed system as discussed in more detail below), conduits 220/225 on the premises are not necessarily intended or configured to help create a positively pressurized system but rather are intended or configured to help create a negative pressure (vacuum) and are made of rigid and/or flexible PVC. While flexible PVC is typically more expensive than rigid PVC, it reduces the install time (e.g., by nearly 50% over rigid PVC) due to connection time, dry fit, glue, etc. In addition, the otherwise long sweep 90 degree elbows of rigid PVC tend to be shorter the 90 degree sweep of the flexible PVC, reducing the friction in the tube delivering salt.

In various embodiments, fill port 250 is configured to be coupled or connected to a delivery hose 670 of transportable system 600 and return port 255 is configured to be coupled or connected to a return hose 675 (e.g., through a firehose or fireman's connection). When not operatively coupled to the transportable system, the fill port may be covered with or coupled with a fill port cap. In various embodiments, the fill port and/or the fill port cap includes a bar-coded label that may be read and/or utilized to help ensure a connection to the correct tank and the correct salt fill or delivery amounts. For example, the bar-coded label may be read by a smartphone or other device and possibly transmitted to a computer onboard the vehicle, or to another server, which associates the bar code with a unique address or tank and the stop-weight limit for that tank at that time or for that delivery. This may be helpful for customers or addresses with multiple tanks such as a carwash or large commercial account as well as assisting in accurate billing for multi-unit buildings under separate or different ownership.

In various embodiments, GPS coordinates of each fill port may be maintained on a computer, server or other system or device in communication with a smart phone or other mobile device, and the coordinates may be used to guide (e.g., by map or directions) the device or user to the intended fill port. This may help reduce any unnecessary delay or expense in hunting for a fill port (e.g., for new or substitute driver not familiar with the location). Further, the GPS coordinates may help to generate or provide a map showing a layout of a building along with the fill port position relative to that building.

In various embodiments, return conduit 225 extends from brine tank 210 to return or exhaust port or outlet 255, which may have a vacuum applied to it during a fill or delivery process, and which may be of larger diameter than inlet conduit 220 (e.g., to reduce pressure that transportable system 600 may otherwise have to produce).

In various embodiments, exhaust outlet 300 and/or return conduit 225 also helps to avoid introducing or remove introduced unconditioned air (e.g., hot air in the summer, cold air in the winter), moisture, humidity, salt dust, household dust or other allergens, truck exhaust, into the structure or premises housing the brine tank. In various embodiments, return conduit 225 also reduces any need for a filter for air escaping tank during a filling process which again, reduces the need to enter the customer premise to change such filters. However, a dust bag or filter (e.g., a disposable filter) may be removably provided on an end of the exhaust outlet or conduit to collect any exhaust/dust.

In various examples of embodiments, the on-site system of inlets, outlets, pipes or conduits, and brine tank is configured to be pressurized during salt delivery. By designing, developing and employing a pressurized tank and piping system, there are several benefits. For example, pressurization helps to contain salt and salt dust in the system to help prevent salt dust from escaping into the structure or premises. The pressurized system also allows containment of the installed brine tank to help prevent no salt dust from entering the structure and/or premises during delivery.

While the system described herein may be used with known tanks, in various embodiments, the tank includes a float (not shown) provided outside the brine tank. The purpose of the float system in brine tanks is as a secondary stoppage in case of water overfill. In known tanks, the float is located inside the brine tank, and the fragile parts of a brine tank system are located underneath the “brine” solution. This can be a primary cause of tank failure because the parts such as valves, seals, etc., are more susceptible to damage or corrosion. By moving the float outside the tank, the amount of fatigue or corrosion on float parts may be reduced. Also, the float is more accessible and does not require entry into the brine tank for service. Rather, in various embodiments, the brine tank is merely a reservoir for salt.

Referring now to FIGS. 2-4, in various embodiments, the on-site system includes a salt monitoring system 355. In various embodiments, salt monitoring system 355 includes one or more sensors or types of sensors. In various embodiments, salt monitoring system 355 includes a sensor housing 360. In various embodiments, salt monitoring system 355 communicates salt depth data (e.g., over a connector 357) to a network interface module (NIM) 359.

In various embodiments, sensor housing 360 is mounted or coupled to tank lid 270. As illustrated, sensor housing 360 may be mounted or otherwise provided in the approximate center or middle of tank lid 270. Such positioning of sensor housing 360 relative to lid 270 and/or brine tank 210 helps allow for an angled or undulated surface of salt within tank 210 to be “averaged” by a sensor included in sensor housing 360 without the need for multiple sensors or other sensors inside tank 210, thereby reducing or minimizing cost and complexity. Furthermore, to the extent that a sensor is a laser sensor and has “tunnel vision” in the laser signal sent toward salt in the tank, it is preferable to have a maximum radius for reflection. That is, while in various embodiments, sensor housing 360 (and its sensor) may be mounted anywhere on tank lid 270, mounting the sensor near a side or margin of tank lid 270 may cause reflection and a reduction in the accuracy of a measured salt depth.

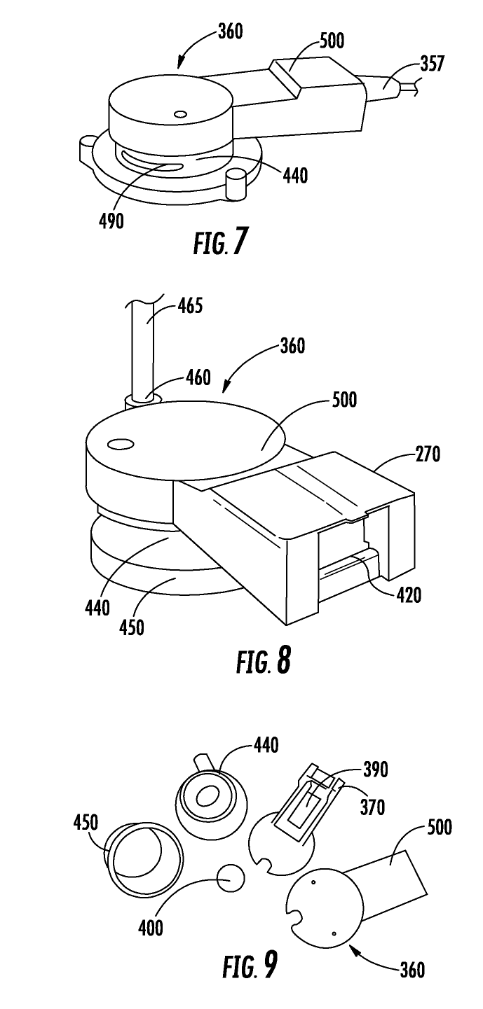

Sensor housing 360 is shown in more detail in FIGS. 7-13. In various embodiments, sensor housing 360 houses a sensor 380 and a sensor circuit board 390. In various embodiments, sensor housing 360 includes a cradle 370 for receiving and/or retaining sensor 380 (e.g., a lidar sensor) and/or sensor circuit board 390.

In various embodiments, sensor housing 360 includes a glass member 400 to help protect sensor 380 while allowing sensor 380 to optically transmit and receive. In various embodiments, cradle 370 includes a foot 410 to help maintain sensor 380 relative to glass member 400. In various embodiments, foot 410 helps securely hold circuit board 390 and sensor 380 in between glass member 400 and cradle 370 by applying some pressure between sensor 380 and glass 400, and also prevents the need for mechanical fasteners to hold the circuit board 390 in place. In doing so, in various embodiments, pressure between sensor 380 and glass 400 (e.g., applied using foot 410) improves sensor 380 reading accuracy and/or range. In various embodiments, cradle 370 also includes a port 420 for connector 357 (e.g., RJ45 connector) (e.g., to couple it to the network interface module (NIM)).

In various embodiments, glass member 400 allows laser light to transmit through glass member 400 while preventing ingress of dust into sensor 380 and/or circuit board 390 electronics. In various embodiments, glass member 400 is approximately 1.2 mm in thickness or another thickness, which optimizes clarity of optics with glass strength.

In various embodiments, sensor housing 360 includes a coupling 440. In various embodiments, coupling 440 receives a sleeve 450, helps retain or hold glass 400, and/or routes air from one or more inlets 460 and/or one or more ports 470 (e.g., for vacuum pressure relief and/or glass cleaning) defined in or by coupling 440.

In various embodiments, coupling 440 helps provide a base for a “sandwich design” to keep sensor housing 360 and sensor components in contact with each other. By sandwiching sensor 380 (e.g., lidar sensor) between glass member 400 and the bottom of circuit board 390, and using plastic extruded housing foot 410 to help provide pressure from inside of plastic housing 360 against the top of circuit board 390, in various embodiments, sensor 380, circuit board 390, and glass member 400 components are held fairly securely relative to each other. In various embodiments, housing 360 helps maintain and/or keep an angle and pressure consistent between sensor 380 and glass member 400, as well as between sensor 380 and tank lid 270. In various embodiments, coupling 440 helps securely retain or hold glass 400, preventing dust ingress. For example, in various embodiments, coupling 440 includes a bevel 480 to help prevent accumulation of salt dust between glass 400 and housing components which may interfere with sensor 380 optical reading ability (e.g., by preventing reflection from salt into a receiver of sensor 380). In various embodiments, inlet 460 of coupling 440 helps hold an air inlet line 465 (e.g., by acting as a socket for the air inlet line 465 to seat into housing 360). In various embodiments, air line 465 is a poly tube (e.g., to prevent crushing and to help keep line open).

In various embodiments, coupling 440 routes air from air inlet 460 to exhaust ports 470 in coupling 440 (e.g., to help clean glass member 400 and/or to act as a vacuum relief point to brine tank 210 during or following a salt delivery).

In various embodiments, exhaust ports 470 are angled up toward glass member 400 bottom. In various embodiments, air inlet line 465 is routed from housing 360 to the outside of the premises. This allows compressed air to be pumped in from outside a structure or building, to housing 360 and through exhaust ports 470 of coupling 440, to help remove contaminants such as salt dust accumulated or deposited on glass during a fill process. However, such cleaning with air may be unnecessary using the sensor housing embodiment with vent ports 490 in the side (coupled with the vacuum bias) as illustrated in FIG. 7. In various embodiments, and as illustrated in FIG. 7, air may also or alternatively be drawn or vented in through one or more vent ports 490 due to a difference in pressure between the inside of the brine tank (e.g., during vacuum bias) which air may help provide vacuum relief and/or clean glass member 400.

Referring more specifically to FIGS. 8-9, in various embodiments, air inlet 460 of coupling 440 includes barbs (e.g., plastic extruded barbs) inside air inlet 460 which grab onto air inlet line 465, and help prevent extraction of air inlet line 465 from housing 360 or, more specifically, housing coupling 430. That is, in various embodiments, while air is carried through air inlet line 465, during a fill operation, or during unusual stress or pulling forces (e.g., someone bumping or pulling on air inlet line 465), the barbs help hold the air inlet line 465 inside coupling 440.

In various embodiments, and referring again to FIGS. 8-10, sensor housing 360 includes sleeve 450. In various embodiments, sleeve 450 screws into coupling 440 to help keep housing 360 secure and dust resistant. In various embodiments, sleeve 450 helps hold or retain housing 360 securely from under tank lid 270. In various embodiments, sleeve 450 basically acts as a hollow “bolt” to mating threads of coupling 440 (which coupling 440 in turn acts as a nut). In various embodiments, sleeve 450 also acts as an ingress protection seal to prevent salt dust from entering housing 360 or exiting tank 210 by substantially sealing male threads of sleeve 450 against female threads of the coupling 440.

In various embodiments, and referring again to FIGS. 7-10 and 12-13, sensor housing 360 includes a cover 500. In various embodiments, cover 500 helps cover and/or protect (e.g., from damage or force) sensor 380 and/or sensor circuit board 390, cradle 370 and coupling 440, and/or electrical port 420 for connector 430. In various embodiments, cover 500 includes a strain relief hook to help hold electrical cords (e.g., any electrical cords or cables coupled between sensor 380 and circuit board 390). In various embodiments, cover 500 also prevents ingress of water, or dust, or salt into housing 360.

In various embodiments, sensor electronics (e.g., sensor and/or circuit board) and/or the sensor housing are electrically grounded. Grounding the sensor electronics and/or housing may help to prevent electrostatic shock from damaging the sensor board or the power supply. Grounding may also help prevent salt from sticking or clinging to the glass via static electricity.

The sensor housing design offers a number of other advantages. For example, in various embodiments, it is rugged to help prevent damage or breakage to the housing, electronics and glass contained or included therein. In various embodiments, it enhances connectivity by providing a connection to the power supply (e.g., via network cord) to the NIM. In addition, in various embodiments, the sensor is securely mounted to the top of the tank or lid to prevent crushing or altering of angle of the sensor to a distance target (e.g., salt).

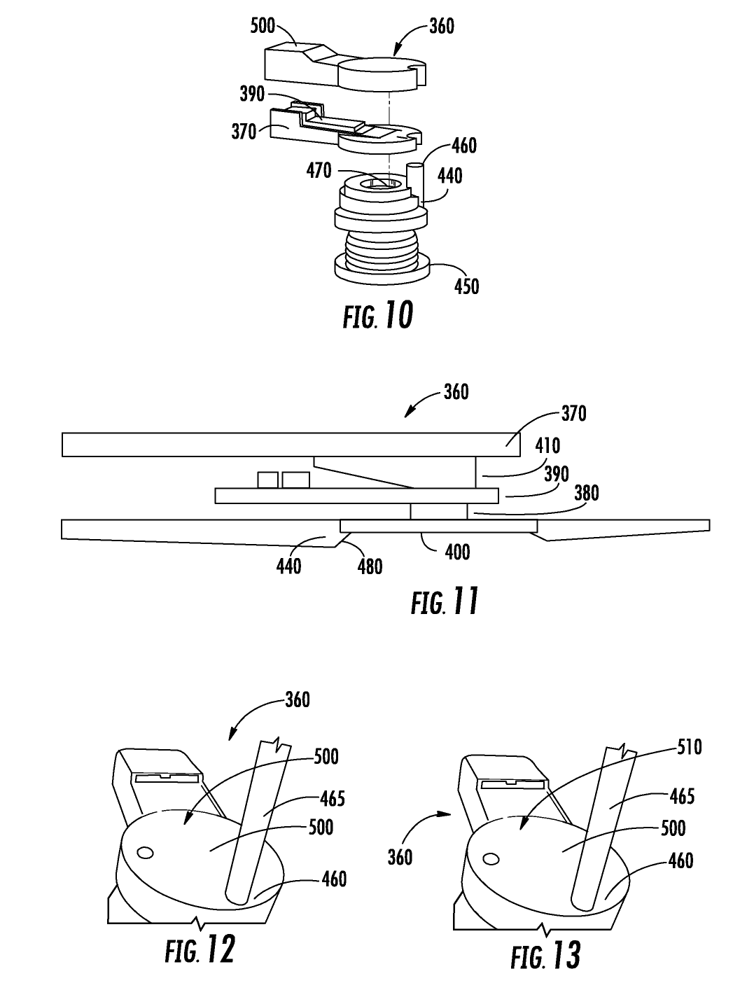

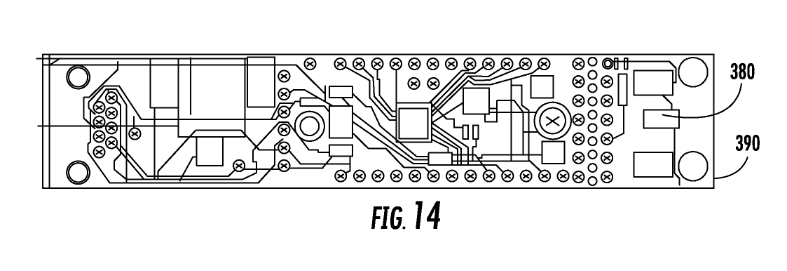

In various embodiments, and as illustrated in FIGS. 12-13, cover 500 is made at least in part of a translucent or semi-translucent material which allows light (e.g., from one or more indicators 510 (e.g., multi-color LEDs to show through the cover). In various embodiments, indicators 510 may be usable to indicate status or power (on), sensor state (e.g., boot up sequence, reading salt depth, software download, etc.), salt delivery, salt levels, etc.

In various embodiments, sensor housing 360 also includes fasteners (e.g., screws) to help hold down cover 500 and cradle 370 to coupling 440, and force or draw with sufficient pressure foot 410 of cradle 370 against sensor 380 and on to glass member 400.

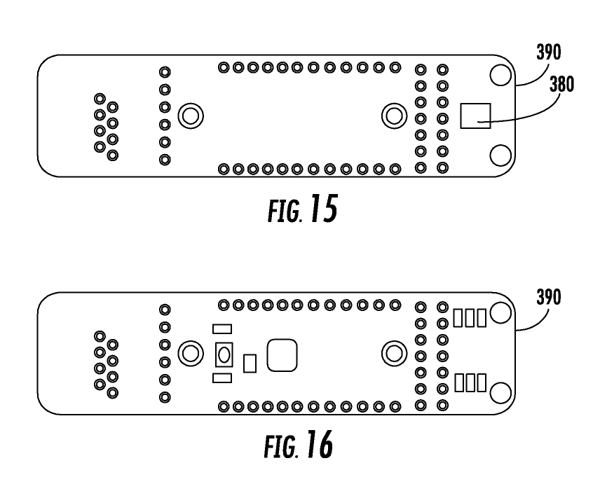

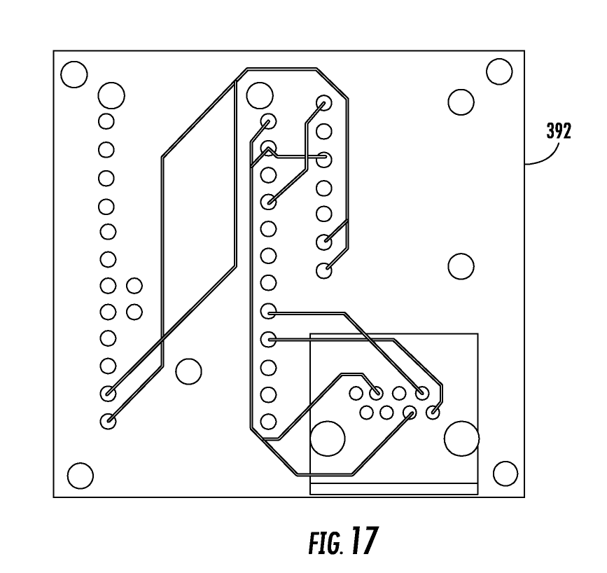

Referring again to FIGS. 14-16, in various embodiments, sensor 380 is a laser sensor (e.g., a small laser sensor). In various embodiments, sensor 380 (e.g., laser sensor) determines and reads the depth of salt in the brine tank and monitors salt level using refraction of light or laser light (e.g., using time of flight). Sensor 380 or laser sensor helps determine or measure a substantially exact and/or accurate salt level or depth of the salt in the brine tank. One or more sensors or laser sensors may also be utilized to measure water level or depth (e.g., while the salt level is below the level of the water in the brine tank). For example, one or more sensors may monitor water level for possible overflow of the tank, as well as indicate a time to power off a water softener if water levels are too high and/or reach a shutoff valve. As another example, when water softener valves fail, they often fail in an open position, which overflows the tank at least to the point of shutoff by the plunger, which is a secondary fail safe, but if the plunger fails, the tertiary fail safe is the water overflow near the top of the tank, which simply allows water to pass onto the floor. Sensor 380 may be used to detect and report that the tank (water) level has consistently risen for a period of time, which may indicate a problem in the tank.

In various embodiments, sensor 380 is a lidar-based sensor, which has a range of at least about two meters. While any current or later-developed sensors may be utilized, the VL53L0X model laser sensor from ST Microsystems is utilized in various examples of embodiments, as it measures from about two meters accurately, within one-half inch, even at seventy-eight inches of depth in darkness. In various embodiments, sensor 380 is tuned to be configured for high accuracy and long distance (e.g., instead of for speed (fast measuring speed)), to maximize accuracy. In various embodiments, sensor 380 is calibrated to measure through glass.

However, it should be appreciated that other types of sensors may be used, such as and including infrared and ultrasonic sensors. For example, ultrasonic sensors may be provided in a low point of a brine tank (such as a low salt point). The low salt point in brine tanks is commonly near a float and valve assembly (typically contained in a white tube). Ultrasonic sensors may also be utilized to measure the depth of the water after the salt level drops below the water line. Infrared (IR) sensors may also be utilized. For example, infrared sensors allow reflection from the salt surface better than ultrasonic sensors which typically perform best against a larger flat target surface. In another embodiment, a lidar-based, volume-measuring sensor which topographically maps a 2D or 3D surface is used to measure the refill volume of salt required. In another embodiment, a scale beneath the tank connected to a network interface may be used to measure the weight of the tank and contents to determine the necessary refill weight of salt required.

In various embodiments, multiple sensors or types of sensors may be used, one or more for measuring salt level or depth and/or one or more for measuring water level or depth. By using multiple sensors (e.g., at the top of a tank, at a plurality of locations in the tank) to monitor salt depth, more accurate mapping of the top of the salt level may be achieved. Salt height may differ in various parts of the brine tank. For example, brine tanks tend to use more salt near a plunger and or water supply tube in the tank. One or more sensors may also be rotated or moved in the tank (e.g., using automation) to various positions in the tank to obtain a plurality of sample points of salt depth and achieve a more accurate overall determination of salt level or need.

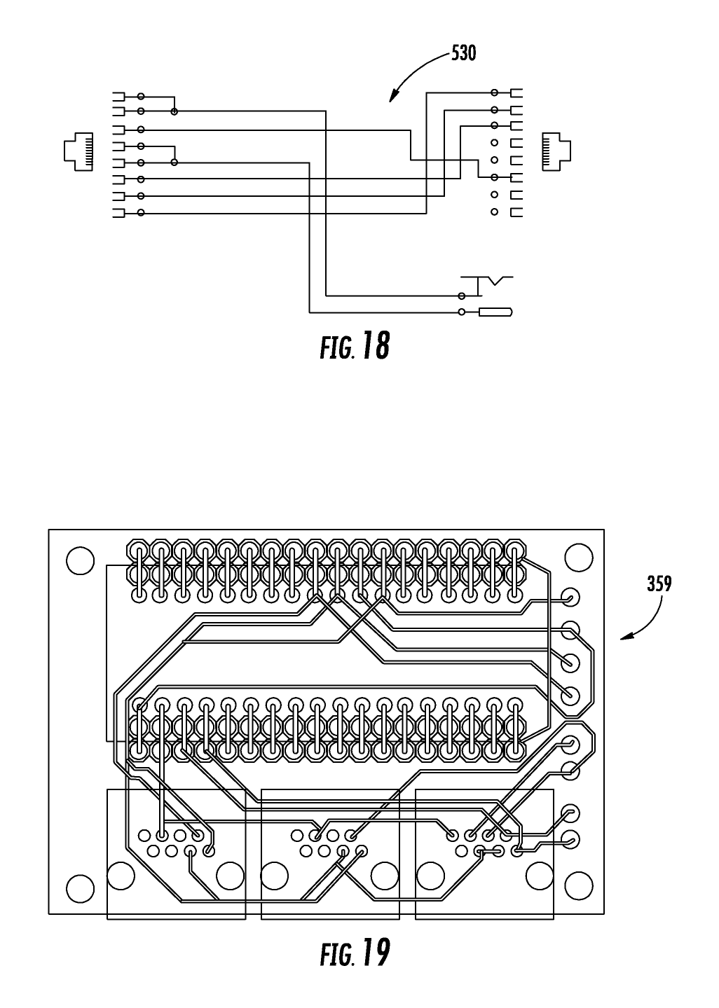

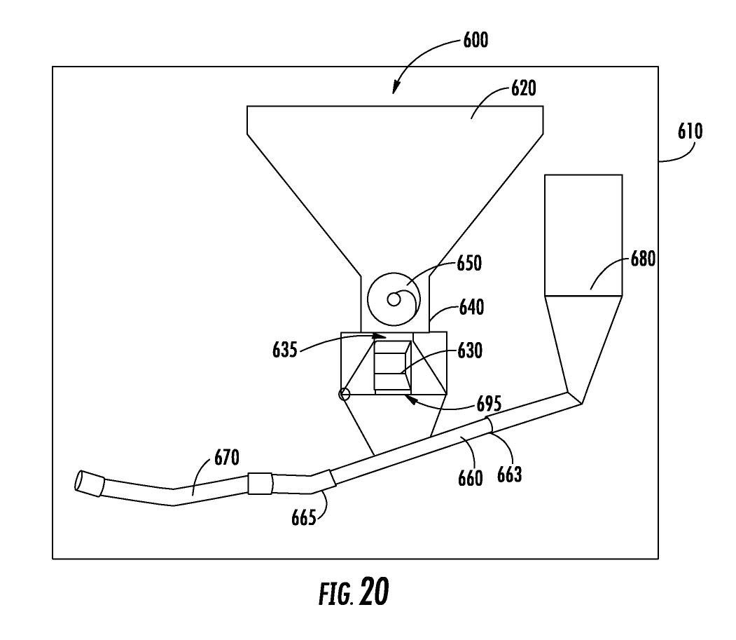

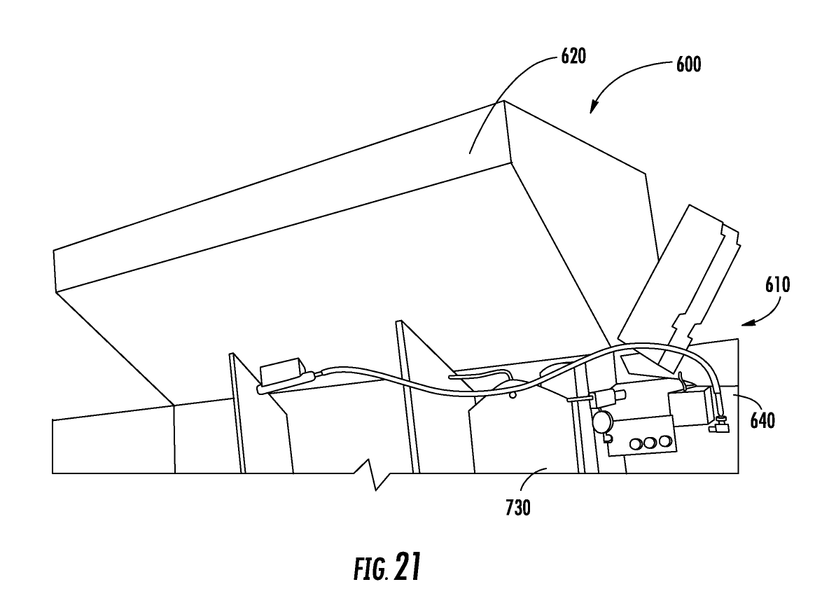

Referring now to FIGS. 14-16, in various embodiments, the salt monitoring system includes one or more sensor modules, circuit boards or single board computers 390 (e.g., located on or near the tank) useable to control and/or monitor one or more sensors 380 (e.g., over a Power-Over-Ethernet (POE) cable), and communicate data and information from sensors 380 or a sensor module 390 (e.g., over a RJ45 cable). For example, and referring now to FIG. 19, data may be communicated to a control motherboard or network interface module (NIM) 359. Network interface module (NIM) motherboard 359 may read incoming data from sensor module or circuit board 390 and send or communicate that data (e.g., over a wireless network) to a server (e.g., cloud server) and/or a network interface module (NIM) Management System (e.g., for metrics and analytics).

In various embodiments, and referring again to FIGS. 14-16, the one or more sensors or sensor modules 380 are in communication with one or more sensor circuit boards 390 (e.g., that reside in, on or around the brine tank). In various embodiments, circuit boards 390 are single board computers connected to sensor(s) 380.

In various embodiments, sensor 380 and sensor circuit board 390 are integrated (e.g., to reduce design cost and complexity). In various embodiments, sensor 380 is on one surface or face of sensor module or circuit board 390 (e.g., the bottom of circuit board 390) and the other electronics are on the opposing surface or face of the circuit board (e.g., the top of the circuit board).

In various embodiments, by providing sensor 380 on one face or surface and providing other components such as electrical components, solder joints, electrical connections and/or pins, which would compete for space in and around sensor 380, on the other or opposing surface, sensor 380 is retained a distance proud (or away from) of supporting circuit board 390 and helps reduce interference from those other components. In addition, in various embodiments, by preserving the bottom of board 390 for this component (sensor 380), the open area or adjacent open space on circuit board 390 allows for intimate contact between the glass and sensor 380, which improves sensor reading depth performance, prevents dust accumulation on top of the glass which may otherwise impede reading performance, and/or seals sensor 380 port openings against the glass which prevents dust ingress into the ports on sensor 380 (which ports may send and receive light (e.g., for the operation of a time-of-flight sensor)). In addition, providing sensor 380 on the bottom surface of circuit board 390 allows for a more horizontal design, rather than a vertical one (where sensor 380 is held at a substantially right angle or perpendicular to a longitudinal axis of circuit board 390). This horizontal design reduces construction cost and complexity and also allows for an integration of all components onto a single circuit board instead of two or more boards (e.g., a horizontal and a perpendicular board holding the sensor).

In various embodiments, an Arduino processor or board is operatively coupled to circuit board 390 (e.g., to provide lower cost, long-distance access to control sensor 380). For example, the Arduino board may allow for remote rebooting (using loopback (two RST—D6 pins) on Arduino board) and/or remotely setting registers in Arduino board using commands (using two pins on Arduino board). In various embodiments, an eight-wire cable jack may be coupled to the Arduino/sensor board to help allow seamless connection to a network board. In various embodiments, an eight-wire cable with a solid-copper wire is utilized to help minimize voltage loss across distance. In various embodiments, Tx/Rx signals on a twisted pair may be utilized to extend length of serial communications.

In addition to the example embodiments shown in FIGS. 14-16, a schematic of another example of a sensor module or board 392 which resides in or near the brine tank is shown in FIG. 17, according to various examples of embodiments. In various embodiments, sensor circuit board 390/392 is made of a polymer resin which is durable and resistant to salt, water, and sunlight. This prevents breakage, prevents breakdown due to chemicals or extreme temperature.

In various embodiments, sensor module 390/392 summarizes sensor data (or data received from sensor 380) and communicates summarized sensor data to the network interface module (NIM) (e.g., using serial communications over the RJ45 Ethernet cable—which may be used for cost and available length advantages over RS-232 or similar serial cables). Ethernet cables may also be built to custom lengths. Also, wireless communication may be used between the sensor or sensors or modules and network boards, but currently tends to be less reliable and less secure and may not allow power to be run via the cable to the network interface module (NIM) (and may require another power outlet and/or supply near the NIM).

In various examples of embodiments, the network and the sensor boards may be combined. That is, LTE Cat M1 technology can currently penetrate through walls, and sustain up to a ten-year battery life (from a battery pack). A disadvantage may be an inability to service the board or upgrade the technology without entering the premise. A Zigbee network board may be used which operates on a mesh network platform, eliminating the monthly cost of the 3G or 4G service, albeit may be lower in throughput or data bandwidth.

In various embodiments, the sensors are tuned by the system within the sensor modules to high accuracy and long distance (e.g., per the manufacturer's recommended settings). A plurality of sensors allows for measurements at different points in the tank or different tunings. Different sensor positions in the tank may increase measurement or determination accuracy as the surface of the salt can undulate as it is consumed.

Referring again to FIG. 19, an example embodiment of network interface module (NIM) circuit or motherboard 359 is shown. As shown, and in various embodiments, network interface module (NIM) motherboard 359 is configured to support connection of up to three sensor modules or boards (e.g., using RJ45 cables). In various embodiments, a Particle.io circuit board is utilized as a network interface module (NIM) circuit board, as it can support up to four remote connections.

In various embodiments, network interface module (NIM) 359 is a single-board computer such as a circuit board or motherboard. In various embodiments, network interface module (NIM) 359 is configured to transmit data or information received from the sensor module to a network interface module (NIM) management system (e.g., over a 3G cellular network or other Internet or data network). While network interface module (NIM) 359 is configured in various embodiments to utilize 3G GSM connectivity, it may also use other connectivity such as: xBee and 4G LTE Cat M1, LoRa connectivity. The network interface module (NIM) may also be a Zigbee or Wi-Fi module adapted or configured to communicate either directly with a vehicle (or a drone) to allow collection of data from one or more customers (e.g., remote customers without cellular coverage).

In various embodiments, network interface module (NIM) 359 is also configured to handle security, error handling, and status communication to a central server. It may also handle firmware updates of the network interface module (NIM) itself, as well as updates to the sensor modules.

Referring now to FIG. 18, a Power-Over-Ethernet (POE) cable 530 is illustrated. Power-Over-Ethernet cable 530 may be an off-the-shelf POE cable except that, in various embodiments, the length of the cable is longer than typical off-the-shelf cables to allow for connecting to a sensor module that may be within the brine tank. In various embodiments, a female end of cable 530 is connected to the male end of an RJ45 cable connected to sensor module or circuit board and the other end of the RJ45 cable is connected to the network interface module (NIM) motherboard or circuit board where serial communications are used to exchange sensor data, and software updates.

While the disclosed on-site system is intended to utilize a sensor such as a lidor sensor, the salt monitoring and delivery system may include, or incorporate, other or additional monitoring systems. For example, the salt monitoring and delivery system may include a camera module tank monitoring system. In various embodiments, camera module tank monitoring system includes a camera module that is utilized to help monitor the level of salt in a salt tank. In various embodiments, the camera module tank monitoring system may include one or more reference points such as a ruler, tape measure, or color coding (e.g., for each 6 inches of brine tank) that would help indicate (e.g., with color and/or numerics) that can be captured as an image, forwarded to a common server, and even translated by a computer imaging system to convert the captured image to a numeric actual measurement.

As another example, the salt monitoring and delivery system may include a light sensing strip tank monitoring system. In various embodiments, the light sensing strip tank monitoring system includes a strip of light-sensing sensors connected together and to a common processor. The strip may have spaced-apart light sensors (e.g., a light sensor every three inches). As the salt level goes down each sensor of the strip is exposed to a light source introduced at the top of the tank. The light may be either artificially lit by LED or natural light from the sun or whatever. The light sensing strip may sense the exposure of the light coming through the top of the tank, and then send a signal to a small processor which may be used to determine the bottom-most light sensor exposed to the light, thereby allowing for measuring the level of salt in the tank.

As another example, the salt monitoring and delivery system may include a clear view tank monitoring system. In various embodiments, the clear view tank monitoring system includes an at least partially clear brine tank. For example, an entirely clear tank or a clear “strip” down an edge or side of the tank may allow for external visual or electronic monitoring. For example, the clear tank may visually show the salt level without removing the lid, or opening the traditional black plastic brine tank. A clear strip down the side of the tank may also show the level without removing the lid. The visible level may either be monitored visually or monitored using a more automated system disclosed herein such as a camera module tank monitoring system. In another embodiment, a light source shown or visible through the clear portion may be monitored by a camera or light sensing device to detect salt level. Even a strip of clear or semi-opaque circles or dots along the side of a black tank may show through allowing for a camera system connected to a computer to electronically count the white dots or a light sensing system to correspond to each clear opening to determine the salt level in the tank.

As another example, the salt monitoring and delivery system may include a hydraulic scale weight-based tank monitoring system. In various embodiments, the hydraulic scale weight-based tank monitoring system includes a flexible hydraulic tube mounted along the inside of the tank which is deflected by the pressure of salt in the tank. In various embodiments, the hydraulic scale weight-based tank monitoring system includes a hydraulic vessel connected to the tube which allows for collection of the hydraulic fluid. In various embodiments, the more salt in the tank, the more the deflection of hydraulic fluid pushed out of the tube into the vessel. The more salt in the tank, the higher the weight of the hydraulic fluid. In various embodiments, the system acts somewhat like a typical glass thermometer where the mercury expands or contracts into the bulb of the thermometer. In various embodiments, the weight of the hydraulic fluid is measured to determine the level of salt in the tank. In various embodiments, the hydraulic vessel weight is measured by a computer scale attached to a network board which transmits that weight to a cloud-based system.

As another example, the salt monitoring and delivery system may include a suspended scale tank monitoring system. In various embodiments, the suspended scale tank monitoring system includes a hanging or suspended scale (which may act like a tank liner) that measures the weight of the salt in the tank much like a hanging scale except it sits inside the brine tank, and the more salt in the tank, the more it weighs, and therefore, the more the scale moves towards the bottom of the tank. In various embodiments, the scale has holes in the perimeter sides to allow the salt to mix with water, but the holes are small enough to prevent the salt from falling or passing through the holes. In various embodiments, the scale is connected to a NIM to send measured weight to a cloud server.

The salt delivery system may also include systems or devices for tank maintenance. For example, salt bridging in brine tanks is common which is caused by the connection between salt pellets where moisture is present allowing salt to bind between the pellets. If enough pellets connect and bind, it prevents the salt from dropping into the water of the tank, eventually preventing the creation of brine water. In order for the softener to begin proper operation again, the salt bridge must be broken, forcing the bridge to collapse into small chunks which fall into the bottom of the tank. Salt may also accumulate in the pipes or hoses of the closed-looped system. This may occur due to temperature differences between the outdoor and indoor air in the premise, causing moisture to collect in the piping. As the moisture collects and salt is delivered through the pipe, the moisture attracts salt dust and causes the salt or salt dust to cake over time.

In various embodiments, the salt monitoring and delivery system includes a salt clearing or de-bridging device. In various embodiments, the salt clearing or de-bridging device (e.g., a salt beater) is an agitator connected via cable or flexible rod which rotates by being connected to a motor outside the brine tank or building. In various embodiments, the salt clear or de-bridging device is configured to break up bridged salt in the tank or piping system without entering the premise.

In various embodiments, the salt clearing or de-bridging device includes a motor or drill, coupling a flexible shaft connecting an agitator to the end. In various embodiments, the agitator is configured to spin at the same rate as the motor or drill or perhaps geared to spin faster or slower depending upon need. In various embodiments, the agitator is shaped to allow either a cleaning of the inside of the pipe as well as a drilling action into the salt in the event the salt bridge is below the surface of the salt, where the bridge is often found to be. The agitator may be designed to dig into the salt and break it up. The pipe cleaning may be performed with a stiff-bristled circular brush attached to the rod, designed to loosen salt dust. In various embodiments, a camera system may be combined on the flexible rod or shaft to allow a user to see the salt bridge prior to or while clearing it.

In various embodiments, the salt monitoring and delivery system includes a tank cleaning system. For example, while a typical brine tank can be cleaned by removing the lid, and using a wet-dry vacuum to extract the contents of the tank, the lid of the closed system is not easily removable in various embodiments.

In various embodiments, the tank cleaning system includes a vacuum tube or hose routed into the brine tank. In various embodiments, the tank cleaning system is utilized in combination with the salt clearing system to help break down the salt into small enough chunks to be vacuumed up by the tank cleaning system. In various embodiments, the vacuum tube has a flexible shaft adjacent to or inside of the vacuum tube to improve effectiveness of the breaking down of the material as well as the vacuum action optimal to removing the chunks. In addition, pressure may be introduced into the tank to help the vacuum to draw air and salt out of the tank, into the vacuum collection system. A tank cleaning system may have a cyclonic separator to allow the removal of solid material from the liquids or other material found inside the brine tank.

Referring again to FIG. 2, on-site system 200 may include or be electrically coupled to a power supply. In various embodiments, the power supply routes regulated voltage from single board computer (or NIM) 359 outside the structure to single board computer (or sensor module) 390 on or inside the tank, which in turn powers one or more sensors 380. The power supply may be a standard off-the-shelf low voltage switching power supply except, in various embodiments, it has two amp power output at five volts, designed to both power the sensor board 390 as well as sensor(s) 380 and charge the battery through a circuit board voltage regulator on single-board computer (or NIM) 359. In various embodiments, a battery of or electrically coupled to network interface model (NIM) 359 may also provide power both to the NIM and the sensor board in the case of loss of other power.

In various embodiments, one or more inlets or fill ports and outlets or exhaust outlets are housed within a box or access (not shown). The box or access may also house electronics and an antenna of the network interface module (NIM) of the on-site system. The box may be lockable outside the business or residence to prevent any foreign objects from entering the fill port or other tampering.

The inlets and outlets may be capped or covered with insulated caps to avoid heat loss in the winter as well as condensation on the outside of the conduits or pipes within the business or residence.

In various embodiments, air (e.g., climate-controlled air) from the home may enter or be allowed to enter the box (e.g., from the, or around the, inlets or outlets) which may be useable to maintain a reasonable or working temperature in the box or access to help condition the temperature of the electronics (e.g., NIM). In various embodiments, the housed electronics may help heat the inside of the box. One or more power sources (such as a battery) may also be provided in the box or access.

Referring now to FIGS. 2 and 20, salt delivery apparatus or vehicle 610 of transportable system 600 is illustrated, according to various examples of embodiments.

Salt delivery apparatus or vehicle 610 may be any type of vehicle including a truck or a trailer. In various embodiments, vehicle 610 is a truck. In various embodiments, the truck does not exceed 26,001 pounds GCWR (gross combined weight rating) fully loaded and does not have capacity to exceed more than two persons, thereby eliminating any required commercial driver's license or CDL. The passenger front seat of the vehicle may be removed to make room for a computer system, while leaving the middle seat intact so at least one passenger can ride along if necessary.

In various embodiments, the salt monitoring and delivery system includes a salt scooter to help avoid long runs of hose, and to help provide access to fill ports otherwise inaccessible. For example, in various embodiments, the vehicle is a salt scooter or modified vehicle (like a walk-behind lawn mower) with components of the transportable system installed thereon.

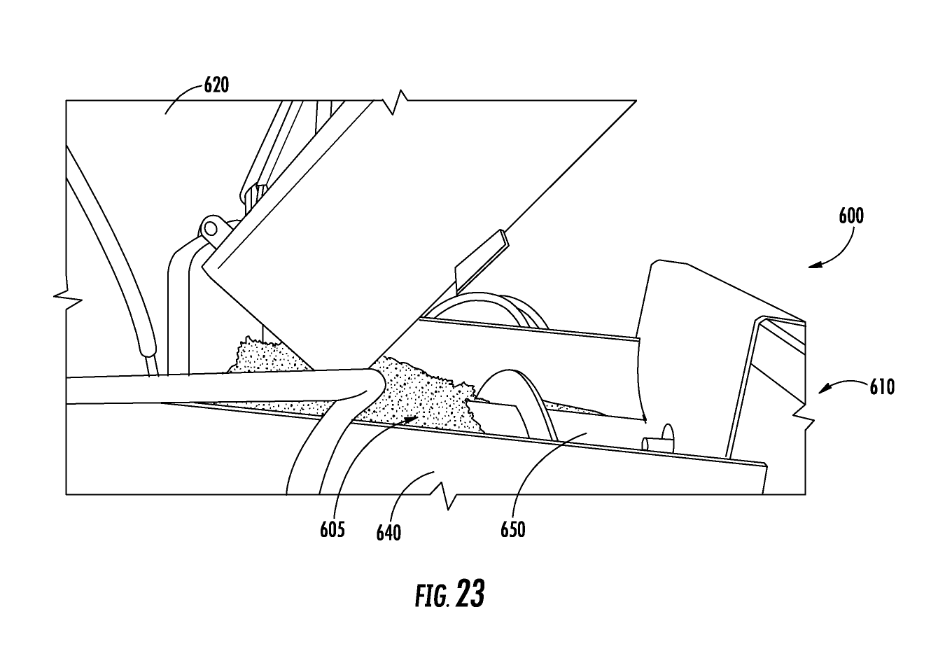

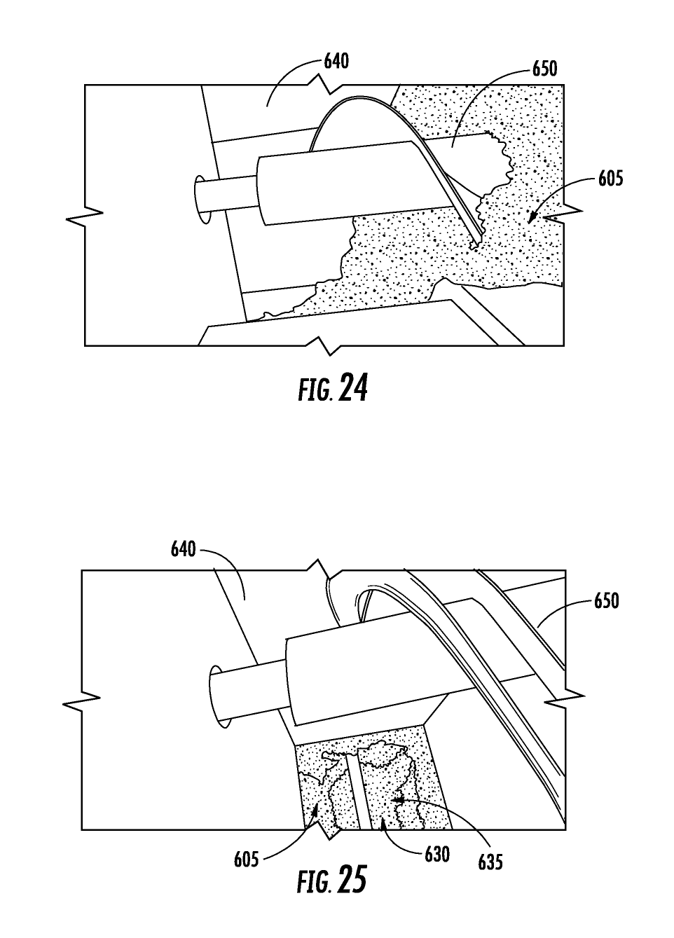

Referring more specifically to FIGS. 2 and 20-26, in various embodiments, transportable system 600 includes a salt source or hopper 620 for holding and transporting salt 605 (e.g., by vehicle 610) to one or more locations (e.g., locations requesting or requiring salt 605). In various embodiments, salt is provided into hopper 620. Salt may be loaded into hopper 620 in a variety of ways. For example, equipment such as a skid steer or front end loader may be used to load hopper 620. As another example, vehicles may be loaded below grade.

In an example embodiment, hopper 620 has a capacity to hold up to 10,800 pounds or five cubic yards of salt 605. In various embodiments, salt delivery apparatus or vehicle 610 of salt delivery system 600 also includes additional equipment and components for providing salt 605 from hopper 620 to a location outside hopper 620, such as the on-site system for receiving and holding salt 605 and, more specifically, one or more brine tanks. For example, hopper 620 helps contain or hold salt 605, which may then be transferred or provided through a transfer box 640 by an auger 650 on an end of hopper 620 to a valve 630 such as a rotary, feeder or valve.

In various embodiments, the salt delivery system includes hopper 620 with auger 650 to push, move, or introduce salt 605 from hopper 620 into transfer box 640, to rotary valve 630 to a mixing bin or container or mixing tube 660, and into a delivery hose or conduit 670. In various embodiments, the transportable system and method for delivery of salt includes an airflow or airlock system that includes a number of components (e.g., hopper 620, rotary feeder 630 such as a rotary airlock valve, and a fluid moving apparatus 680). One benefit of using air instead of, for example, a pressurized water-salt mixture, is improved accuracy in weighing and distributing a desired or predetermined amount of salt. Because liquid may not be needed to push salt through the system, deliverers and customers can obtain a more accurate measurement of the product being delivered.

In various embodiments, auger 650 is provided partially or substantially in hopper 620, and protrudes into transfer box 640. In various embodiments, transfer box 640 helps house a portion or protrusion of auger 650 outside of hopper 620. In various embodiments, it also helps to provide space for the transfer of salt to rotary valve 630. In various embodiments, auger 650 helps pull (or push) or introduce salt from hopper 620 to transfer box 640. In various embodiments, the operational speed of auger 640 is measured in RPMs, and helps to control the overall salt delivery rate (e.g., by controlling the amount of salt provided into rotary valve 630) to help regulate salt or product delivery and avoid overfill or clogging in salt delivery system 600 (e.g., in mixing tube 660 or delivery hose 670). If needed or desired, the speed of rotary 630 and auger 650 may be increased to provide faster delivery of salt into one or more brine tanks.

In various embodiments, salt delivery system 100 is an airlock system. While various types of valves may be utilized in the system, in various embodiments, valve 630 is a rotary airlock valve. In various embodiments, auger 650 may be utilized to deliver or convey salt to rotary airlock valve 630. In various embodiments, the use of rotary airlock valve 630 allows fluid moving apparatus 680 to move salt from the salt source or hopper to a brine tank or salt bin while maintaining the flow of material and helping seal the system against loss of air. Without an airlock system, it may be difficult to produce the amount of pressure needed to blow salt through components, conduits, and piping of various sizes or ranges of sizes. In various embodiments, rotary airlock valve 630 helps provide an “air-lock” system so that air pressure in the system (e.g., air pressure generated at least in part by the fluid moving apparatus 680) does not negatively affect the flow of salt through the salt delivery system. For example, in various embodiments, the air-lock (e.g., rotary valve, butterfly valve, etc.) helps sufficient or optimal air to be pushed through the system without causing a pressure imbalance, which could result in a “blow back” or “bubble” that prevents material from passing without first “purging” the line.

In various embodiments, rotary valve 630 helps optimize the disclosed system. In various embodiments, rotary airlock valve 630 acts as a seal between transfer box 640 and mixing tube 660 while moving material from transfer box 640 to mixing tube 660, thereby helping avoid or minimize “blow back” or “turbulent” air, or other air pressure buildup (e.g., caused by resistance from the salt) that may cause the salt to double-back or otherwise get pushed back in the direction of hopper 620 (or away from the brine tank), or generally abrade or erode rotor assembly or other system components. By using a “rotary valve” in an “airlock” system, pressure moving the product through the lines is substantially maintained and less prone to back up and create a “bubble” of negative air pressure.

It should be appreciated that there are other apparatus that may be utilized to provide a similar “airlock” system. For example, a similar “airlock” system or type system may include multiple valves (e.g., butterfly valves) that may be actuated in separate steps to help create a backlog of pressure (e.g., to release into the system).

While FIG. 26 illustrates rotary airlock valve 630 having an eight-vane rotor 637, it should be appreciated that valve 630 may have any number of vanes (e.g., six or ten). In various embodiments, rotor 637 is constructed of non-corrosive or corrosive resistant materials such as stainless steel, aluminum or plastic or other similar materials or combinations of materials. In various embodiments, a closed-end rotor assembly is utilized in valve 630 to help reduce wear and failure caused by salt. It should be appreciated, however, that an open-end rotor assembly may also be used.

In various embodiments, the rotary valve includes a release valve (e.g., on the bottom side of the rotary) to help maintain or promote a steady form of airflow that is generally unobstructed by other system components.

Referring again to FIGS. 20 and 24-26, in various embodiments, transfer box 640 is utilized to help move, direct or provide salt 605 from the hopper to a depressurized or unpressurized side 635 of rotary valve 630 while helping protect salt 605 from elements prior to entering rotary valve 630. The salt delivery system may be set up and/or positioned such that gravity helps move salt 605 from transfer box 640 into valve 630. In various embodiments, unpressurized side 635 of rotary valve 630 receives salt 605 from the gravity drop of transfer box 640 as moved or pushed by auger 650 to pressurized side 695 of rotary valve 630, which then drops salt 605 into the air/salt mixing tube 660 and pushed by the fluid moving apparatus. In various embodiments, rotary valve 630 helps ensure that the air pressure coming from the fluid moving apparatus is contained such that it is prevented from escaping from the mixing tube to unpressurized side 635 of valve 630. That is, it prevents air and/or salt, dust, etc. from blowing back past rotary 630 and out of transfer box 640 or the hopper. In various embodiments, rotary valve 630 also helps control the rate at which salt 605 enters the mixing tube.

Referring again to FIGS. 2, 20 and 27-28, in various embodiments, transportable system 600 of the salt delivery system includes fluid moving apparatus 680. In various embodiments, fluid moving apparatus 680 connects or is coupled to pressurized side 695 of rotary valve 630 and/or mixing tube 660 and helps propel salt in mixing tube 660 sufficiently (e.g., fast enough) to get it substantially airborne.

In various embodiments, fluid moving apparatus 680 is or includes a positive displacement blower or pump. In various embodiments, and as more specifically illustrated in FIG. 28, the positive displacement pump includes multiple (e.g., two) gears 700. When in operation, gears 700 create both a positive pressure side or zone 710, as well as a positive vacuum side or zone 720. In various embodiments, positive pressure side 710 and positive vacuum side 720 are applied to the brine tank through conduits and system, and the system including or utilizing both positive pressure 710 and vacuum side 720, while fluid moving apparatus 680 is running during salt delivery, helps introduce salt into the brine tank while creating a nominal, zero or negative pressure or vacuum bias in the brine tank.

While a rotary or other blower may be utilized as fluid moving apparatus 680, the positive displacement pump or blower offers advantages over other such blowers. A positive pressure bias in the tank (even a small positive pressure system), may cause salt dust to leak out of one or more orifices in the tank or piping system. The use of a positive displacement and/or vacuum bias created by a positive displacement fluid moving apparatus 680 allows the system to keep the brine tank near, at or below atmospheric pressure levels during delivery. This is optimal for the system because existing brine tanks are not typically engineered to withstand much positive pressure, and introduction of such pressure without adequate vacuum bias or relief may potentially damage existing tanks and lead to added safety and/or customer satisfaction concerns such as uncontrolled salt dust (e.g., as observed in known systems).

Such pressure levels and/or vacuum bias also help the system to work well on most existing tanks without significant concern about salt dust, pressure, or allergens entering the premises. It also reduces cost and installation time, not requiring a new or significantly modified tank to support a pressurized tank. Further, a vacuum bias system reduces any need for compression hose lines.

In addition, a positive displacement pump or blower (and the positive displacement and vacuum bias) may help move salt more efficiently to promote or increase delivery range and/or the speed at which salt is moved (e.g., by pushing and pulling an air-salt mixture), which helps reduce delivery times and may lead to more deliveries per period of time.

Referring back to FIG. 2, in various embodiments, transportable system 600 includes mixing tube 660. In various embodiments, transportable system 600 includes delivery hose 670 in fluid communication with mixing tube 660. In various embodiments, mixing tube 660 is angled downward from a fluid moving apparatus end 663 of tube to a delivery hose end 665 of tube 660. The tube may also be substantially level between its opposing ends.

In various embodiments, mixing tube 660 receives salt from valve 630 and air from the fluid moving apparatus 680, thereby mixing salt and air and sending salt exiting rotary valve 630 into mixing tube 660 airborne. Once airborne in mixing tube 660, in various embodiments, the salt is provided or pushed into delivery conduit or hose 670 and ultimately into a brine tank.

In various embodiments, delivery hose 670 is pressurized during a delivery operation. In various embodiments, rotary valve 630 helps to maintain pressure in delivery line 670 to ˜2 psi above atmospheric pressure.

Referring again to FIGS. 2 and 28, which illustrate various components of the salt delivery system, in various embodiments, salt delivery system 100 may be a substantially “closed-loop system.” In various embodiments, a pressure side 710 of fluid moving apparatus 680 (pumping air and salt into a brine tank via brine tank input 290) is operatively or fluidly coupled or connected to brine tank 210, and brine tank output or return conduit 225 coming from tank 210 is operatively or fluidly coupled or connected to a low pressure or positive vacuum side 720 of fluid moving apparatus 680 (thereby making a substantially closed-loop air system). By coupling return pipe 225 to low pressure or positive vacuum side 720 or input of fluid moving apparatus 680, there may be a number of advantages. For example, in various embodiments, the pressure in tank 210 is reduced or negligible or negative (e.g., having a slight vacuum bias) during salt delivery which improves safety (e.g., for the tank and people near tank 210 or on the premises 230) and helps eliminate salt dust egress from brine tank 210 (or other parts of the salt delivery system) into premise 230. In various embodiments, the closed-loop system prevents introduction of air that may contain contaminants, allergens, unconditioned cold or hot air, etc. out of the system and into the premises, and it reduces dramatic fluctuations in the moisture level of delivered salt. In various embodiments, relatively smaller diameter pipes and hoses may be utilized in a substantially closed system relative to an open system. In various embodiments, smaller diameter pipes and hoses are utilized to allow for higher salt-to-air mixture (as the same volume of air is capable of carrying more salt). The substantially closed loop may also reduce costs by avoiding any need to involve cyclonic separation, any rotary valves at the brine tank, compressed air hose lines (to clean the sensor glass), a sealed or fully enclosed brine tank, etc. Further, the substantially closed system may result in ease of maintenance of brine tank 210 as lid 270 of tank 210 can easily be removed, and the closed system reduces the need for a completely sealed or enclosed brine tank 210 as lid 270 is less likely to separate from or lift off tank 210 during fill due to a lack of any added positive air pressure.

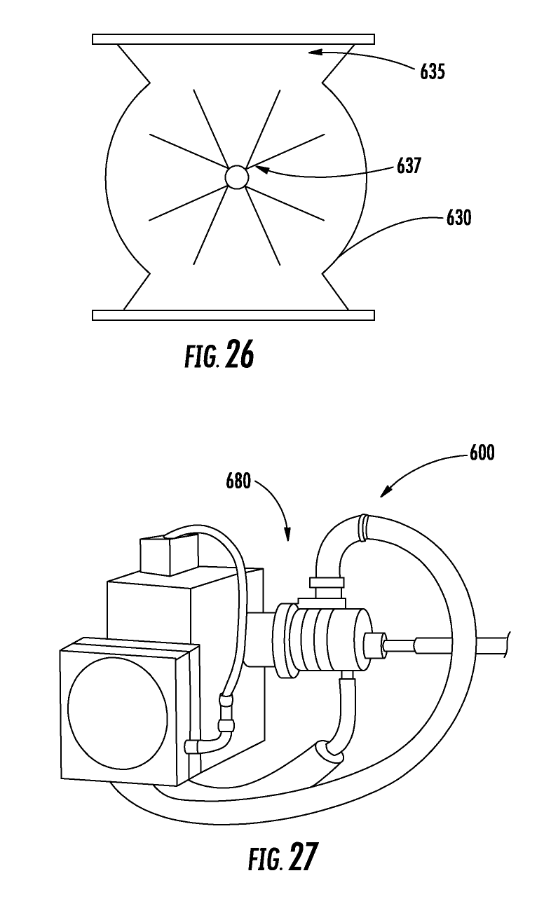

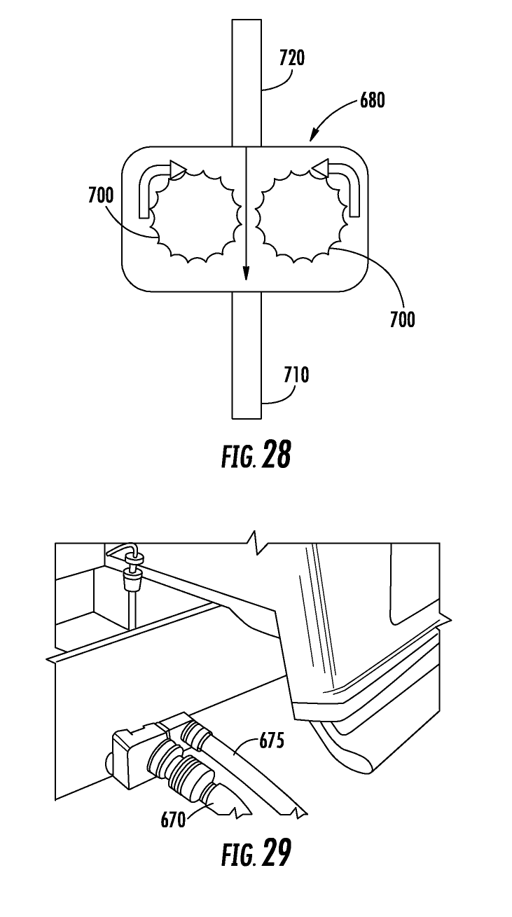

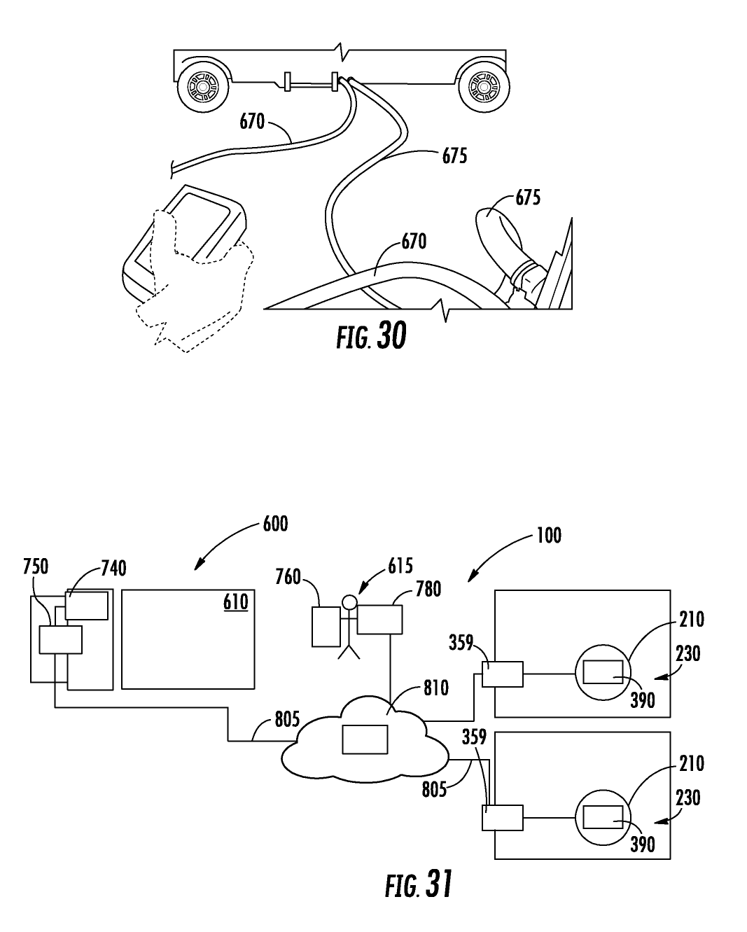

The substantially closed-loop system is designed to help control the airflow in the system 100, connecting output or positive pressure side 710 of fluid transfer apparatus 680 to input or lower pressure or positive vacuum side 720 of the same apparatus (perhaps coupled to a filter or filter canister (see FIG. 27) to help reduce or eliminate cycling of salt dust) to help create a vacuum bias (e.g., in return conduit 675 and system extending from brine tank 210 to fluid moving apparatus 680), which means at brine tank 210 a pressure gauge may read negative pressure (vacuum) during a fluid transfer apparatus cycle as well as during a salt fill cycle. The amount of vacuum may vary depending on whether salt is flowing, but in various embodiments about 0.3 lbs. of vacuum is typical during delivery.

In various embodiments, and referring more specifically to FIG. 2, the disclosed closed-loop system includes: brine tank 210; piping or conduit 220/225 inside premise 230 connecting the brine tank to the outside ports; hoses or conduit 670/675 outside premise 230 connecting the inside piping or conduit 220/225 to mixing tube 660 and air inlet 630; rotary air lock valve 630 to prevent air from escaping the closed system (e.g., into the transfer box or hopper 620); mixing tube 660 to help mix salt and air at the correct ratio to allow it to be more easily or optimally moved through system 100; and fluid moving apparatus 680 (e.g., a positive displacement blower or a rotary blower). In various embodiments, the closed-loop system is substantially airtight (closed). In various embodiments, system 100 includes air inlets (such as, e.g., through components at sensor housing 360 (see, e.g., FIGS. 2 and 7-13)) to allow air to flow past the glass covering the sensor (as described in more detail above).

The transportable system in various embodiments includes auger 650, valve 630, and fluid moving apparatus 680 operating in synchronization (e.g., in terms of operation and/or salt delivery). As mentioned above, in various embodiments, auger 650 helps move salt from hopper 620 to rotary valve 630, and then to mixing tube 660 where the fluid moving apparatus 680 using air pressure provides the salt into delivery hose or conduit 670. If auger 650 is rotating too quickly relative to valve 630, such that valve 630 cannot keep up with the salt provided by auger 650, salt may back up from and around valve 630. Also, if fluid moving apparatus 680 is not running fast enough to mix the salt with the air from fluid moving apparatus 680, salt may clog in mixing tube 660. In various embodiments, a pressure sensor is provided (e.g., near the exit point of the mixing tube or the delivery hose). In an example embodiment, the pressure sensor uses sensor readings to help control the speed of the blower to ensure proper pressure for moving salt or other material a desired or needed distance. In various embodiments, rotary valve 630 and auger 650 speeds or RPMs are monitored to help ensure those speeds correlate with the appropriate fluid moving apparatus 680 speed to prevent clogging and help ensure the needed or desired pressure.

In various embodiments, one or more of transportable system 600 components are driven or powered using hydraulics (e.g., vehicle 610 hydraulics). In various embodiments, one or more of transportable system 600 components are driven or powered using vehicle 610 transmission.

In various embodiments, and referring again to FIG. 2, the vacuum biased system is created and utilized during salt delivery. In various embodiments, salt enters a rotary valve from a hopper (e.g., a hopper located above the rotary valve). In various embodiments, the positive pressure side of the positive displacement pump or blower is linked or coupled to the bottom or exit of the rotary valve. In various embodiments, positive pressure created by the positive displacement pump carries or pushes/pulls salt through hoses, lines or conduit to a positive pressure connection or inlet on a brine tank. A vacuum bias also created by the positive displacement pump pulls pressure (including, e.g., air, dust, etc.) through hoses, lines or conduit back toward the positive displacement pump from a positive vacuum connection on the brine tank and into the positive vacuum side of the positive displacement blower or pump.

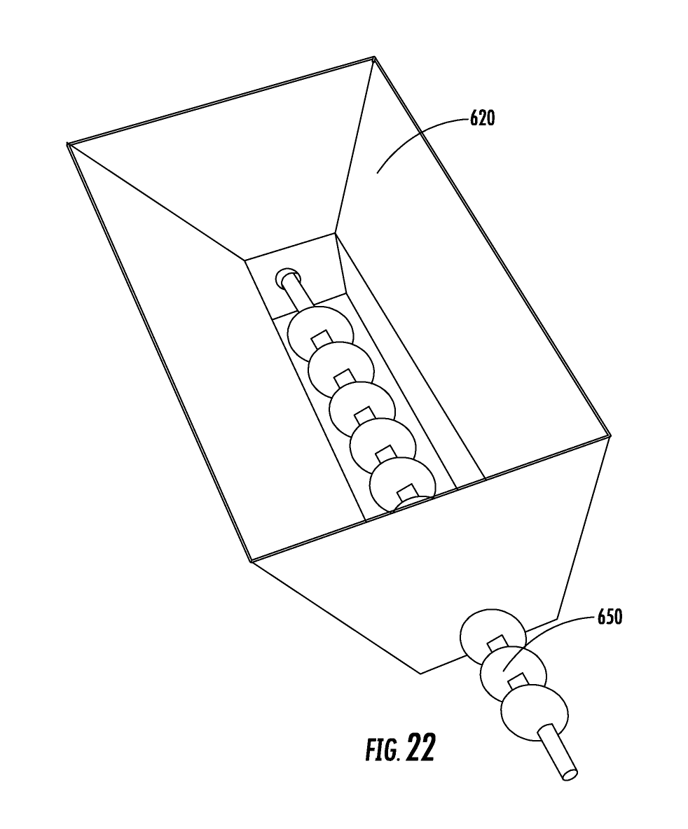

Referring again to FIG. 21, in various embodiments, a weighing or scale system 730 for weighing the salt in hopper 620 is also disposed in or on the salt delivery vehicle 610. In various embodiments, weighing system 730 is a wireless, computerized onboard weighing or scale system including an auto-shut-off at a predetermined weight or change in weight. Using an onboard weighing system with a computerized scale, the salt delivery system (or a component of a delivery system) may be discontinued or powered off at a given or predetermined stop limit point. In various embodiments, the onboard weighing system with a computerized scale may be utilized to shut off the auger at a given stop limit point (e.g., after a measured or predetermined) distribution of salt weight.

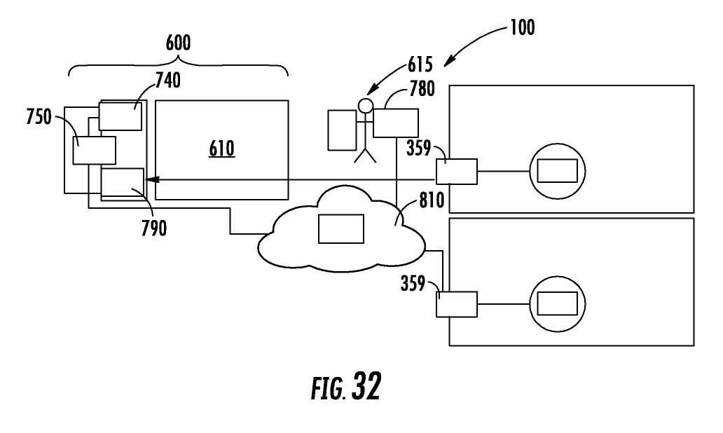

In various embodiments (see, e.g., FIGS. 31-32), transportable system 600 includes one or more computer systems 740/750. In various embodiments, transportable system 600 also includes a remote control 760 in communication with one or more of the vehicle computer systems 740/750. In various embodiments, vehicle 610 includes two computer systems 740/750. In various embodiments, a first or weighing scale computer system 740 configured to monitor the weighing or scale system, and control components of transportable system 600 and, in particular, the auger of transportable system 600. For example, first computer system 740 may monitor an initial weight measurement and a current and/or an ending weight measurement to help make sure to stop or shut down the auger after a predetermined weight of salt has left the hopper. As another example, first computer system 740 may monitor a change in salt weight during delivery and stop or shut down the auger once the change in weight and a predetermined weight are the same. In various embodiments, the onboard weighing system or the weights and measures scale provides a calibrated measurement for state requirements for weights on board.

Remote control 760 allows convenient and/or portable control of transportable system 600 to reduce delivery steps and time, avoiding walking back and forth between vehicle 610 and a premise connection point or fill port to turn on and off various delivery components (e.g., the auger, the fluid moving apparatus, and/or the rotary). Remote control 760 may also have an emergency shut off to quickly shut down some or all components of transportable system 600 (e.g., in case of an urgency to do so). In various embodiments, remote control 760 includes a Lodar 92 Series—FET Systems Model Number LS1664—FM 4 standard transmitter. In various embodiments, remote control 760 allows for a frequency signal up to two hundred feet away from delivery truck 610. In various embodiments, the Lodar system includes standard transmitter and receiver specifications. In various embodiments, delivery agent 615 may connect the delivery hose at the fill port or premise wall inlet connection and use the Lodar FET System to engage or start the fluid moving apparatus, the rotary and the auger, and shut off the rotary and fluid moving apparatus, when in various examples of embodiments, the auger stops automatically at a stop limit distribution weight. In various examples of embodiments, an emergency “stop” (when required) may be implemented to make a full immediate stop of the transportable system.

Second or vehicle management computer system 750 may manage other aspects of vehicle 610 including providing first computer 740 the weight and customer ID of the amount of salt/product to be delivered as well as (a) communication of data and information between a fleet management system and a vehicle system; (b) billing; (c) assisting a delivery in customer location (route optimization); (d) locating fill ports by tank ID; (e) using a map and/or GPS location; (f) providing transportable system 600 status and vehicle 610 location; (g) providing vehicle status (ODBII time-stamped data) for both vehicle state reporting (odometer, mileage, “check engine” light errors) and delivery agent performance monitoring and reporting; (h) customer tank status (e.g., real-time customer tank status); (i) salt load status; and/or (j) delivery route and delivery route optimization (e.g., based on customers' needs, location, and salt load status).

In various embodiments, the vehicle includes one or more containers that includes additives (such as oils, fragrances, chemicals, anti-allergens, skin conditioners, etc.) that may be pumped through a hose (e.g., the delivery hose) or otherwise provided (e.g., directly or by combining it with the salt as it is being conveyed) into the brine tank and mixed in with the brine to modify the water conditioned in the brine tank. For example, the additive may be a lemon fragrance that could be provided in a brine tank providing water to a dishwasher to help give dishes washed in that water a lemony or clean scent. As another example, an additive such as a hydrating solution may be provided in a brine tank providing water to a shower to help prevent dry skin on a person using that shower.

Referring again to FIGS. 31 and 32, a schematic diagram of salt delivery system 100 is illustrated. As shown, in various embodiments, salt delivery system 100 includes a number of computer systems and electronics in communication. For example, as shown in FIGS. 31 and 32, in various embodiments, each of premises 230 includes brine tank 210 and an associated sensor module or customer tank computer or circuit board 390. Customer tank computer or circuit board 390 may be active or otherwise in communication with a network board or a customer networking interface computer (NIM) 359, typically provided on the outside of a structure or premises 230 (e.g., to allow for upgrading NIM 359 as technology improves, as well as allowing one to power off the on-site system by unplugging NIM 359 (if the power flows through it to sensor board 390). In various embodiments, the customer networking interface computers or network boards (NIMs) are in communication with a server such as cloud server 810 using a network such as data or cellular network 805. The data communicated from customer networking interface computer (NIM) 359 to cloud server 810 can then be transmitted to a portable handheld or other mobile computer (such as a handheld or mobile computer 780 on delivery agent 615) and/or to a vehicle computer such as vehicle management computer 750 and/or a vehicle weighing computer or weighing scale computer 740. In various embodiments, and as more particularly illustrated in FIG. 32, data may also be communicated over a Wi-Fi connection between customer networking computer or NIM 359 via a vehicle router 790. In various embodiments, vehicle weighing computer 740 and/or vehicle computer 750 also communicate data to or through a server (e.g., cloud server 810) to a handheld or mobile computer (such as handheld or mobile computer 780 on delivery agent 615) allowing control and/or real-time monitoring of tank 210 status.

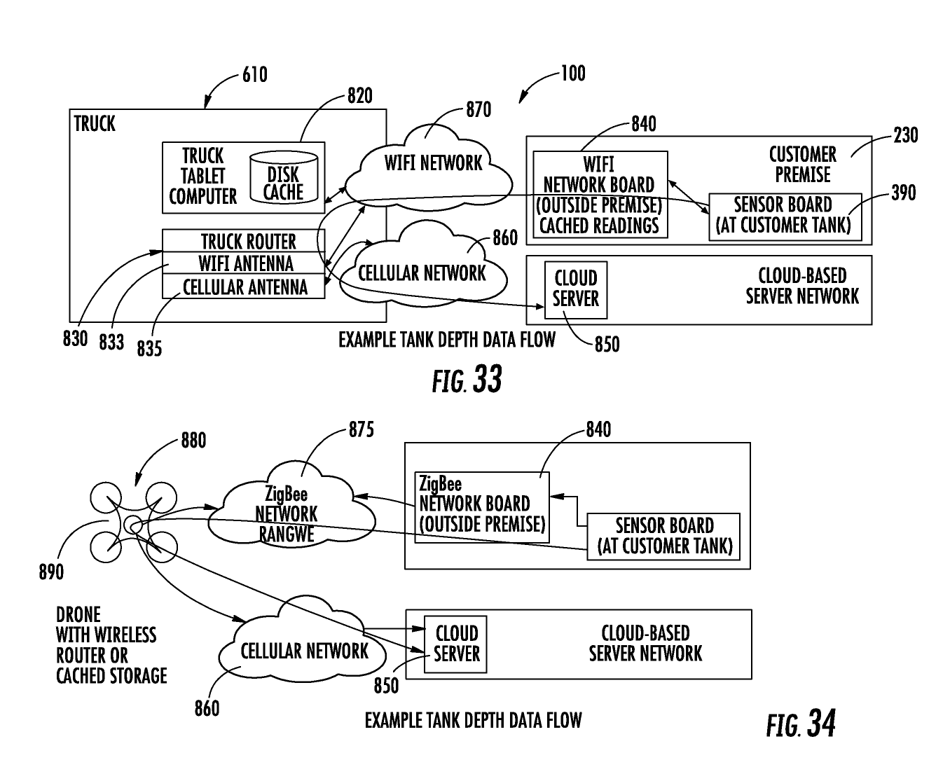

Referring now to FIG. 33, not all customers may be located in an area which has cellular coverage, or cellular which is supported by a carrier chosen or used for a network card SIM. For such customers, salt delivery system 100 may be modified to move data from a network board 840 to a cloud server 850, without live internet data connectivity to network board 840. For example, other ways of moving data real time to cloud server 850 may be utilized. In addition, the data may be stored and later uploaded in batch(es).

In various embodiments, truck or vehicle 610 may be running one or more computers and/or network routers 830, which may communicate directly to a customer network single board computer 840 where, e.g., customer network single board computer 840 is Wi-Fi-enabled and/or cellular enabled. When computer 840 is Wi-Fi enabled (short haul network), customer network single board computer 840 may use vehicle computers 820 and/or routers 830 to act as a bridge to a cloud server 850 via cellular or Zigbee (wide-area) network 860 or act as a data store. That is, vehicle computers 820 and/or routers 830 may act either as a data store and forward platform, or act as a real-time bridge between cellular network 860 and Wi-Fi enabled network board 840, such as illustrated in FIG. 33. In various embodiments, the vehicle computers and/or routers support live upload of data via the customer premise Wi-Fi card or board 840 and cellular network 860. In various embodiments, the data is forwarded or communicated from the customer premise network board 840 to a truck or vehicle computer 830 over a Wi-Fi network 870 which later batch uploads the data to cloud-based server 850. In various embodiments, vehicle 610 is enabled with both Wi-Fi communications or antenna 833 and cellular communications or antenna 835. In various embodiments, the truck or vehicle computer system 830 acts as a bridge between Wi-Fi communications 833 and cellular communications 835 to allow network card 840 to talk through the truck computer and/or router 830 via cellular 860 to cloud server 850. This may be advantageous where truck 610 is running a cellular modem and one or more customers perhaps have 4G coverage in an area, but the customer premise network card is designed to work with a 3G network by another carrier without coverage nearby a given customer. In various embodiments, truck or vehicle 610 also has a computer 820 which caches data received from network card 840 until truck 610 has connectivity either to a cellular network or a Wi-Fi network (e.g., a network owned by the same company) which allows upload of the cached data.

In various embodiments, network board 840 on customer premise 230 uses Wi-Fi connectivity by driving a delivery truck with Wi-Fi network 870 nearby, remaining near premise at least long enough to capture data (presumably cached from several days or hours of reading) in the truck on the single board computer or tablet 820 (for Wi-Fi customers) for temporary storage (e.g., when outside of coverage).

In various embodiments, customer premise-based single board network computer board 840 is configured or designed to send data (e.g., cached from the past few days) to a specific Wi-Fi access point SSID (the publicly visible Wi-Fi access point name). That is, in various embodiments, customer-based network board 840 is provisioned to specific Wi-Fi network 870 from or on truck wireless router 830. In various embodiments, network board 840 stores or remembers the user ID and password for vehicle or truck-based Wi-Fi network 870, and when vehicle 610 brings Wi-Fi network 870 in range of customer premise-based network card 840, one or more things happen. For example, in various embodiments, network board 840 software design has been built or configured such that, upon arrival or during pressure within network range, network board 840 uploads cached data (e.g., the last few days or weeks of cached data) to cloud server 850. However, if computer or cellular network 860 is not in range of vehicle or truck 610, in various embodiments, vehicle tablet 820 may cache this data for later upload when truck 610 travels to an area with better cellular coverage and access to cellular network 860.

In various embodiments, vehicle computer or tablet 820 software is designed or configured to automatically bring up any network boards in range, and display their tank status (e.g., % full). For example, it may automatically bring up a visual representation of each Wi-Fi-enabled network board showing each customer tank level reading upon driving into range of the one or more network cards.

Vehicle tablet or computer 820 may provide a platform in salt delivery vehicle 610. In various embodiments, computer or tablet 820 connects via router 830 with either cellular network 860 (for Internet connectivity) or via Wi-Fi 830 to a network established in truck 610. With Wi-Fi-based customers (any customer outside of the normal range of the cellular network), truck 610 may act as a bridge (e.g., a repeater between different network protocols) or cache (e.g., store and batch forward later).

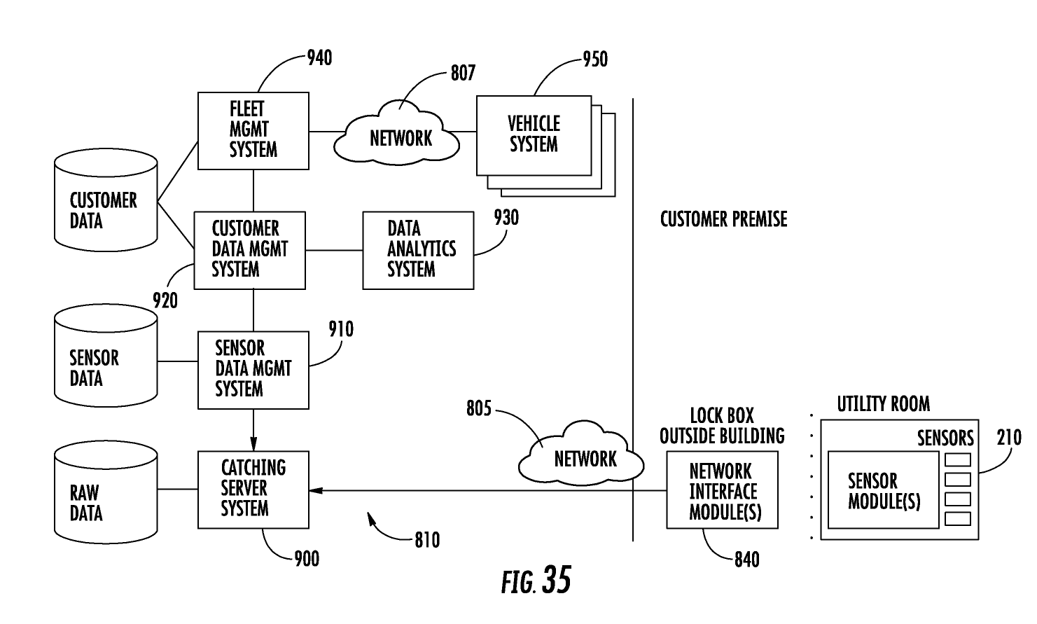

Referring now to FIG. 34, a drone-based wireless coverage system 880 is illustrated. Typically, for wireless coverage in a given geographical area, an antenna tower must be rented or erected which requires land with a high elevation, high cost (permits, construction, power lines, taxes) and maintenance (weather-related destruction, power loss, etc.). The approximate rental cost may be $1-$10 per vertical foot per month, and a 200-foot high antenna may cost $200-$500/month rent or as high as $2,000 per month in higher-density, higher-controlled areas. In addition, cellular towers are typically spaced about five miles apart, which is high density compared to other networking bands. However, wireless-enabled drone or drone-enabled wireless system or router 880 (e.g., enabled with wireless capability of a given frequency and protocol requirements) may ameliorate many of these issues.

In various embodiments, a drone 890 (e.g., acting in similar manner to vehicle 610 in FIG. 33) is launched to communicate with nearby customers (e.g., clustered within a reasonable radius), to allow connection between a drone-enabled wireless router and the customer premise network card 840. In various embodiments, drone 890 uses wireless connectivity to be a data store and forward cache and/or a real-time communication bridge between cellular network 860 and a local area protocol 875 such as Zigbee. Drone 890 may be able to obtain a line of sight to customer premise network card 840 using a vertical advantage while a vehicle may rely on a close proximity to the customer premise network board using protocols designed for shorter haul such as Wi-Fi making local area protocols like Zigbee that do not penetrate building and walls as well as Wi-Fi useable in the case of the drone-enabled wireless communication. However, Zigbee or LoRa may also be an option for a truck or vehicle-mounted antenna.

Wireless-enabled drones may also be used for other industries such as cellular wireless communications (between cell phone devices and the internet—either through communication with another tower or with another drone nearby). Drones may be launched and cycled periodically to recharge the battery, a modest cost compared to erecting and maintaining antenna towers or dispatching a vehicle or truck. By launching the drones every one-half hour for example, one could cover a twenty-four hour period with forty-eight launches, overlapped by a shorter period of time each cycle to maintain constant coverage. In another implementation, a launch may occur at a given time interval (every sixty minutes for five minutes) to collect all the data, and return to base.

In various embodiments, local area protocols 875 like Zigbee, which typically have a 28-mile line-of-sight distance range with low bandwidth, are used to collect sensor data (which typically consists of about two hundred fifty bytes of data each hour). For example, a drone 890 (e.g., coupled to Zigbee) may be launched to perhaps one-half mile in height, which can then “see” line of site an entire town and pull or push data to or from the drone. For example, a launched drone may store data (e.g., sensor data) in a single board computer coupled with a Zigbee network card to later batch unload after landing and/or have its data payload sent over a router which is capable of sending and receiving data (e.g., to read all the sensors (via the network boards)), and network cards may transmit their cached data to the drone, which then allows the router-toting drone to forward data to a cloud server via wireless communications (cellular or Wi-Fi, etc.) and/or store the data and forward it (e.g., to a cloud server) later (e.g., once the drone lands).

In various embodiments, a data plan like one for the Google Project FI, which supports a variety of networks and frequencies as well as local access points, without the single-carrier dependency, using a Google-provided SIM may be utilized as a connectivity option. Such a data plan allows connection based on data usage. An advantage of this option is that it allows the communication independent of a given carrier. For example, Verizon Wireless is inextricably linked to CDMA, which isn't available in all areas. Google FI SIM can use bandwidth from many carriers which essentially are aggregated through Google FI's service. This option may lower the network cost as Google charges by the gigabyte rather than charging by the phone number. That is, additional SIMs are essentially free, limited to data use only, and may work well for the disclosed system.

Referring to FIG. 35, in various embodiments, customer network computer or network interface module (NIM) 840 may also help communicate data or information (e.g., to or over cloud server 810) to and from a number of systems including a network interface module management system or caching server system 900. In various embodiments, the network interface module (NIM) management system or caching server system 900 is a server configured to take or receive data from network interface module (NIM) 840 over a data network 805 (e.g., 3G cellular network) and store it (e.g., using a unique identifier for network interface module (NIM) 840) and send or forward at least some such data (e.g., via a REST API) to a sensor data management system 910 (e.g., over a secure connection). The network interface module (NIM) management system 900 may also handle firmware updates to a network interface module (NIM) 840, as well as clock time synchronization.

In operation, network interface module (NIM) management system 900 is configured to manage registrations of SIM-based network interface modules (NIMs) 840, encrypt data between network interface module (NIM) 840, and network interface module (NIM) management system 900, capture incoming data from network interface module (NIM) 840, persist the data, generate events to network interface modules (NIM) 840, such as fill and query events, and/or forward data to sensor data management system 910.

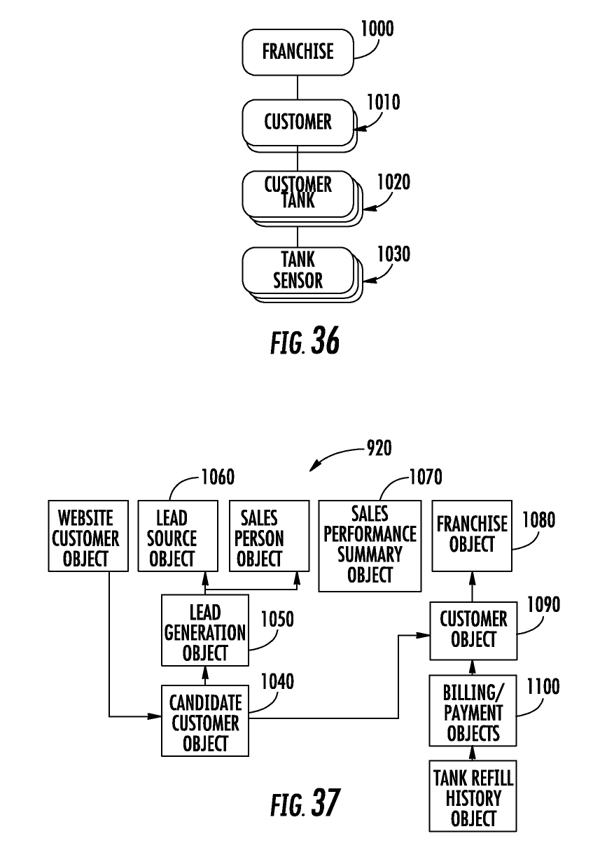

In various embodiments, sensor data management system 910 is configured to manage, store, and provide summary sensor data uploaded by network interface module(s) (NIM(s)) 840 to a customer data management system 940. In various embodiments, sensor data management system 910 uses a REST API to receive and persist the sensor data into a non-SQL database in a tree structure, using a unique identifier representing the respective network interface module which then allows association to a customer. An example tree structure is shown in FIG. 36. In another example embodiment, system 910 monitors both the flow of water into a tank as well as the consumption of salt (based on salt delivery as well as a salt level sensor), and determines the ratio of water consumption to salt consumption. Where a brine tank is using (dispensing) more water than expected (e.g., based on crowd-sourced or historical averages, and/or averages for a specific model of water softener), system 910 may report an unusually high water consumption, and in various embodiments, turn power off to the water softener. Monitoring water consumption may also allow the system to report brine water creation to the consumer, the softener manufacturer, and/or the city water system, to better manage the consumption as well as provide statistical data to any interested parties.

Referring to FIG. 36, in various embodiments, an example tree structure includes a franchise object 1000, a customer object 1010, a customer tank object 1020, and a tank sensor object 1030. In various embodiments, franchise object 1000 represents a franchise owner servicing a particular customer, customer object 1010 represents the particular customer (who may have one or more brine tanks), customer tank object 1020 represents one or more attributes of a tank in which a sensor is installed and a unique identifier of the network interface module (NIM) for mapping upload records, and tank object 1030 includes an upload record.

Referring again to FIG. 35, in various embodiments, customer data management system 920 manages, stores, provides secure customer data, acts as a platform for multiple business units to conduct related activities concerning various points of the customer life cycle including, but not limited to, sales interaction, install preparation activities, install activities, delivery performance and delivery activities, automated billing, customer facing data and support. Additionally, customer data management system 920 may be a connection across multiple platforms, with API connections implemented across systems.

Referring now to FIG. 37, a data model including a customer data management system data model is shown. In various embodiments, customer data management system 920 includes one or more of the following objects: a candidate customer object, a lead generation object 1050, a lead source object 1060, a sales performance summary object 1070, a franchise object 1080, a customer object 1090, and/or a billing/payment object 1100, a “ready for fill” object which is a status indicator to help trigger a delivery, and/or an account status object designating whether a particular account is an active paying customer.

In various embodiments, candidate customer object 1040 represents a potential customer. In various embodiments, lead generation object 1050 includes a set of sales leads representing a collection of leads for a given time frame or selection set. In various embodiments, lead source object 1060 represents the source from which a set of sales leads, or leads to a candidate customer, has been generated or acquired.

In various embodiments, customer object 1090 represents a customer who owns one or more customer tanks. In various embodiments, franchise object 1080 represents a franchise owner to which a customer belongs. In various embodiments, billing/payment object 1100 or objects represents one or more objects tracking customer statements, invoices, invoice items, and payments. In various embodiments, sales performance summary object 1070 represents one or more objects tracking performance summary of sales and other business objectives.

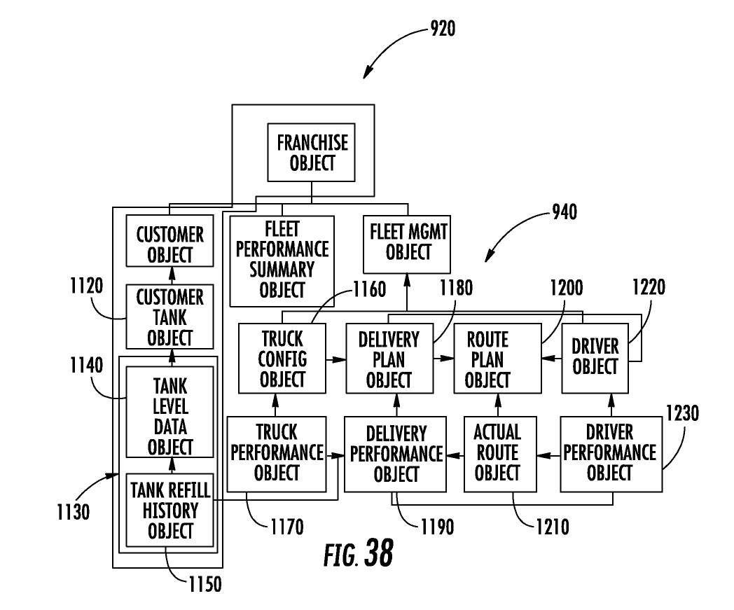

Referring now to FIG. 38, a data model including portions of customer data management system 920 and a fleet management system 1110 is illustrated. In various embodiments, customer data management system 920 may also include other data. For example, customer data management system 920 may include a customer tank object 1120. In various embodiments, customer tank object 1120 represents the attributes of the tank in or on which a sensor is installed as well as a unique identifier of the network interface module (NIM) of the tank for mapping upload records. In various embodiments, customer data management system 920 may also include a tank tracking system 1130. In various embodiments, tank tracking system 1130 includes one or more sets of data including a tank level data object 1140 and a tank refill history object 1150. In various embodiments, a tank level data object 1140 includes tank attributes such as tank size, capacity, location, etc. In various embodiments, tank refill history object 1150 includes refill history data including refill salt amounts, fillings, salt consumption reports, delivery information, etc. In various embodiments, the refill salt amounts are sourced from the vehicle system and fed into billing and salt consumption reports. In various embodiments, tank refill history object 1150 connects to delivery performance and used for determining tank performance as it relates to customer tank object 1120 of customer data management system 920.

Referring again to FIGS. 35 and 38, in various embodiments, certain information in customer data management system 920 is provided to tank tracking system 1130, a data analytics system 930, and a fleet management system 940. In various embodiments, tank tracking system 1130 tracks or includes customer tank background data such as tank model, serial number, capacity, etc., as well as tank use and delivery data such as historical salt levels, usage, refills, etc. In various embodiments, data analytics system 930 is a support platform which uses data to improve business performances, sales, marketing, delivery, route, driver, and/or track performance.

In various embodiments, fleet management system 940 helps manage vehicle operations, communication of data to and from the vehicle computers (route plan, billing, customer, tanks, etc.) by franchise. In various embodiments, fleet management system 940 communicates with one or more vehicle systems 940 (e.g., the second computer system on a vehicle) over a network 807). An example data model of fleet management system 940 is also shown in FIG. 38.

Referring to FIG. 38, in various embodiments, fleet management system 940 includes one or more of the following data objects: a truck configuration object 1160, a truck performance object 1170, a delivery plan object 1180, a delivery performance object 1190, a route plan object 1200, an actual route object 1210, a driver object 1220, and a driver performance object 1230.

In various embodiments, truck configuration object 1160 includes various data information about a vehicle including the manufacturer, model, serial number, size, hopper capacity, hopper model number, blower specifics, rotary specifics, hydraulics system model, etc.

In various embodiments, truck configuration object 1160 may include a truck identifier uniquely describing the vehicle. In various embodiments, truck performance object 1170 includes telemetry or readings of fuel economy by date, time, odometer, RPM information from the auger, blower, and rotary, and ODB-II data.

In various embodiments, delivery plan object 1180 includes one or more objects, indexed by a unique identifier, and including the delivery route based on a variety of information, including one or more of the following: customers, tanks, routes, GPS locations, salt amounts needed, driver and brand truck. In various embodiments, delivery performance object 1190 includes a log of an actual delivery, including the delivery route, truck, driver performance, and refill history (including actual customer stops).

In various embodiments, route plan object 1200 includes a set of objects which defines a route plan for a given delivery route. In various embodiments, actual route object 1210 includes a log of the actual route including actual customer deliveries.

In various embodiments, driver object 1220 includes a set of objects containing information about the delivery agent, their standard work schedule, etc. In various embodiments, driver performance object 1230 includes, for a given route, various information logged to allow reporting of performance on delivery agents including timing of deliveries, performance compared to plan, any safety issues, customer complaints, etc.

Referring again to FIG. 35, in various embodiments, by connecting the sensor(s) with data network 805, salt usage or levels in brine tank 210 may be monitored (e.g., remotely) in real time. Real-time monitoring has numerous benefits, including reduced cost (e.g., reducing the need to manually or routinely check brine tank 210, or visit a site to read a box or indicator outside the structure showing the level), and allowing for replacement of electronics that become obsolete or broken.

In various embodiments, real-time monitoring also allows one or more components of the salt delivery system (such as a mobile device) and/or a delivery agent helping operate the system to receive real-time updates of the brine tank salt level before, during and after refill. This may eliminate the need for any display or indicator on the outside of a building or structure housing a brine tank, which display or indicator could require frequent repair or replacement.

In various embodiments, data networks 805/807/875/960 include (3G cellular (specifically 3G GSM), 4G cellular (specifically 4G LTE Cat M1) and mesh networks (xBee or Zigbee). It should be appreciated, however, that any known or later-developed networks may be utilized.

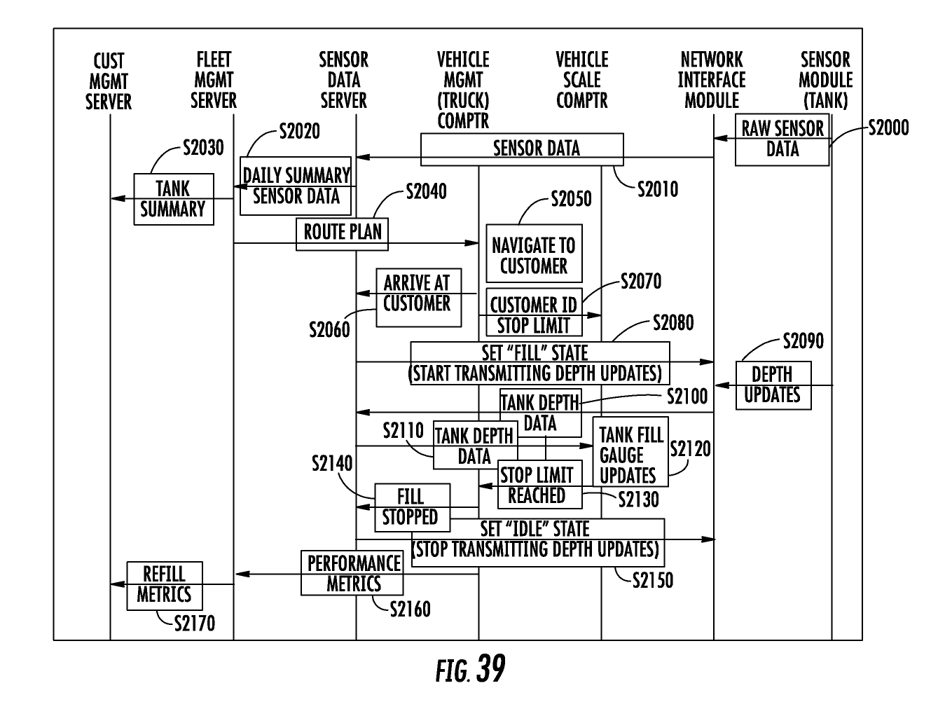

Referring now to FIG. 39, a sequence diagram illustrating dataflow between the various computer components of the salt delivery system according to various examples of embodiments is illustrated. In operation, in various embodiments, an individual or entity (e.g., a salt delivery service or agent) installs an on-site system and collects and records information and/or data about the on-site system. Such information and data may include, among other things, the number of building occupants; the water source (e.g., city water (incl. name of city) or well water); the model number of the softener; the serial number of the softener; the brine tank capacity, height and/or size (e.g., in pounds of salt); and the length and diameter of interior tubing or conduit between the outer wall and the brine tank.

In various embodiments, an optimal or maximum fill or refill depth is also determined. In various embodiments, the optimal or maximum refill depth is determined by measuring the distance from the top of the brine tank or a sensor in the brine tank to a point or level in the tank located at or about the salt level of a full tank (or a point or level in the tank located a margin of safety (e.g., one to two inches) below the salt level of a full tank).

As shown in FIG. 39, in various embodiments, in step S2000, raw sensor data is communicated from the sensor module to the network interface module (NIM). In various embodiments, the network interface module (NIM) receives data from the sensor module and sends it over the data cellular network (or other network (e.g., Internet network)), handling metadata, security, error handling, status communication to the network interface module (NIM) management system, it also performs over-the-air firmware updates of the sensor modules.

In various embodiments, in step S2010, the one or more sensor modules receive raw sensor data from the sensors (e.g., distance (in mm) to target), and accumulate and summarize that data into JSON formatted blocks (which is a key/value pair data representation model), and send the JSON formatted blocks via the network interface module (NIM) to a server (e.g., Sensor Data Server) as metrics data. An example sample of three data messages follows: . . . {n:0,s:77,m:2037,r:2}, {n:0,s:78,m:2000,r:2}, {n:0,s:79,m:1984,r:2}, . . . where: the initial “{” open bracket is the start of the data object in JSON format, the “}” is the JSON close bracket ending the object; “n:” is the JSON key for the sensor number, where sensors are number by their connection pins on the single board computer; “s:” is the JSON key for the sequence number, which increments by 1 for every message; “m:” is the JSON key for the millimeters measured from the sensor to the target; and “r:” is the JSON key for the range status as described by the ST Microsystems VL53L0X lidar-type range sensor.

Referring now to FIG. 40, which illustrates a state diagram for a NIM module, in various embodiments, the network interface module (NIM) has multiple (e.g., four) states of operation: an initiate state 1240, an idle state 1250, a query state 1260, and a fill state 1270. In various embodiments, during initiate state 1240, the network interface module (NIM) reports measured or determined salt depth captured at a given interval (e.g., 20 s) for a specific count (e.g., five), then goes to a second state, idle state 1250. In various embodiments, idle state 1250 allows the data upload to be checked, and/or to help make sure the upload and sensor is working (e.g., by sending one or more measurements to the cloud server). The network interface module (NIM) remains in idle state 1250 until a query time interval (e.g., a time between measurements or determinations (e.g., one hour) expires. At the expiration of the query time interval, the system fires a third state, query state 1260. In query state 1260, the network interface module (NIM) captures or otherwise determines a salt depth measurement (then determines the measurement to be uploaded based on a median observation of multiple (e.g., seven) samples), uploads an upload record the determined measurement along with any metadata (e.g., software version, network interface module (NIM) state, a timestamp (e.g., GMT time), and/or any metrics (such as raw JSON data from the sensor module), and then returns to idle state 1250. A fourth state of operation is fill state 1270. In fill state 1270, in various embodiments, the system sends measurement or salt level data continuously or substantially continuously until the fill operation is complete to allow real-time or near real-time monitoring.

Using data obtained in query state 1260, the one or more sensors are utilized to determine the distance from the sensors to the current salt level (or the distance from the top of the brine tank to the current salt level) and, using the brine tank capacity, height and/or size, and optimal or maximum fill or refill depth, used to determine the amount of salt needed to refill the tank to its optimum or maximum fill or refill depth.

For example, the amount of salt needed to refill the tank to its optimum or maximum fill or refill depth may be determined using the following method:

Refill lbs.=((salt depth−max refill depth)/tank height)×tank size in lbs.

For example, if the one or more sensors indicate that the distance from the top of the tank to the current salt level is measured as 20″, and the overall tank height is 32″, the distance from the sensors to the optimal or maximum fill or refill depth is 4″, and the tank size is 300 lbs. (exclusive of the float in the brine tank), the amount of salt in pounds needed to refill the tank to its optimal or maximum fill or refill depth may be calculated as follows:

Refill size in lbs.=((20−4)/32))×300 lbs.

Refill size in lbs.=(16/32)×300 lbs.

Refill size in lbs.=0.5×300 lbs.

Refill size in lbs.=150 lbs.

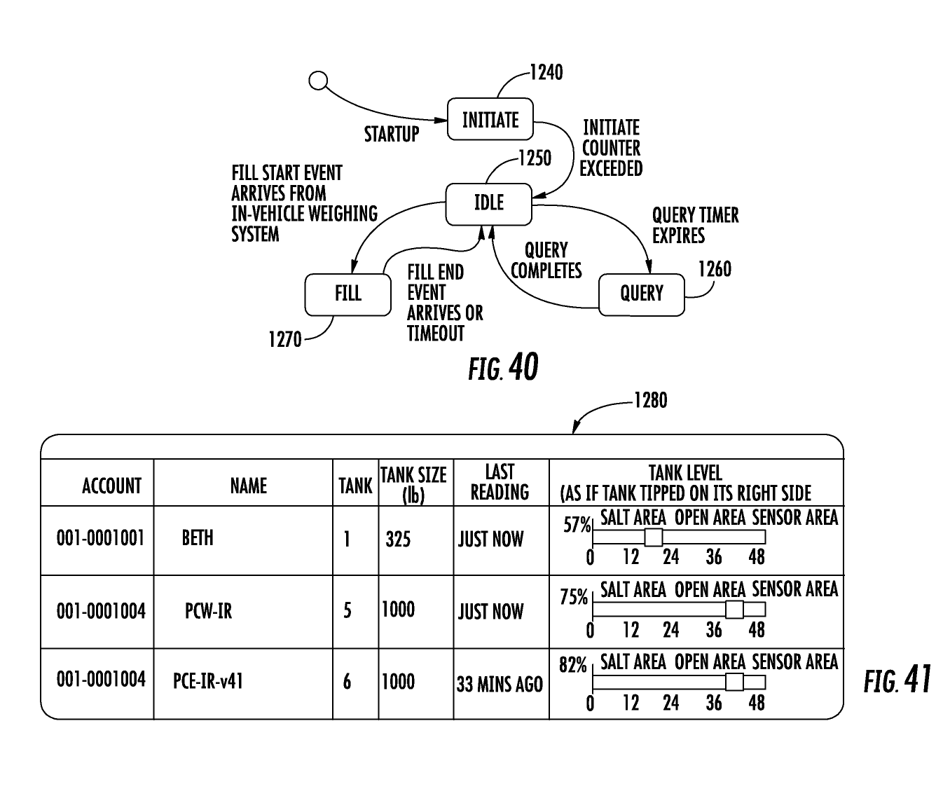

Referring again to FIG. 39, in step S2020, the sensor data server, and/or sensor data management system may then communicate the refill size data to the fleet management server. In various embodiments, in step S2030, the fleet management server may communicate and/or generate to the customer management server a report indicating the amount of salt needed to “fill” or “refill” the brine tank and/or that the brine tank contains a measured amount of salt. For example, as illustrated in FIG. 41, the fleet management server may also use the calculation or determination for one or more brine tanks to generate a summary page 1280, showing customers' tanks, and the status of each tank (e.g., as if the tank were tipped onto its side (e.g., as shown in FIG. 41)). Such an individual tank history view may be useful for analyzing or understanding salt consumption over time, as well as at a point in time.

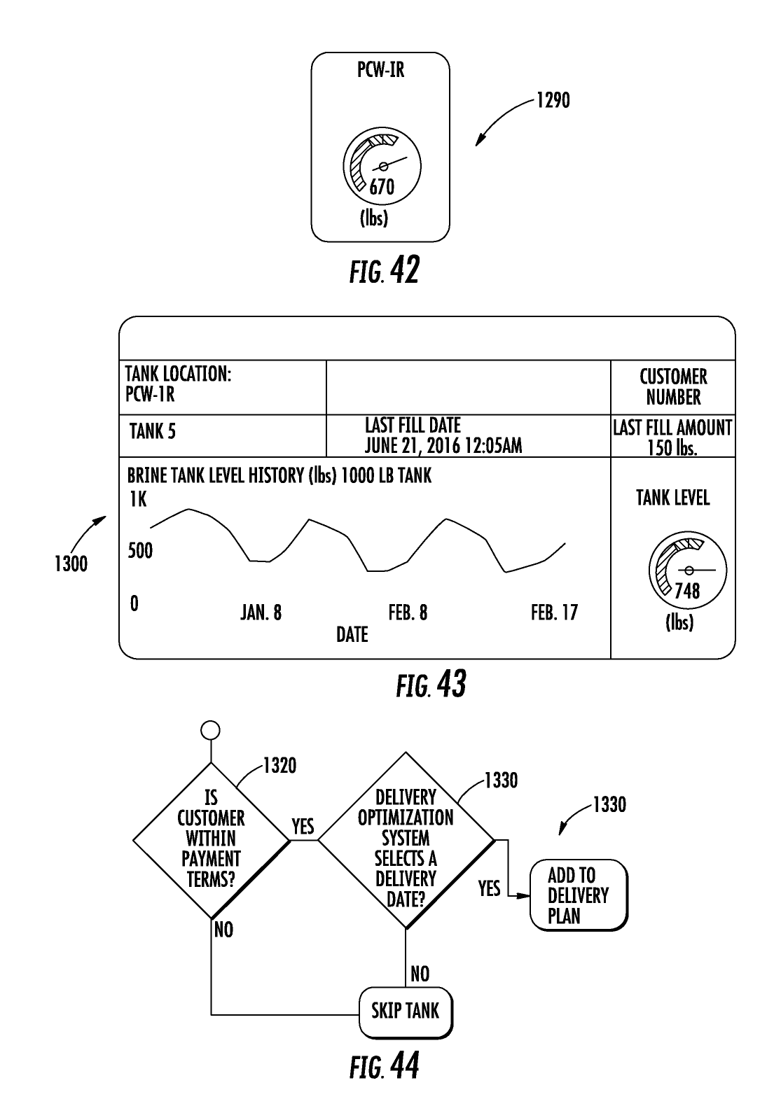

Also, and referring now to FIG. 42, a report, such as a current tank status report 1290, may also be communicated in real time to a mobile or smartphone device or application. Also, and referring again to FIG. 43, a tracking report 1300 tracking salt levels (including consumption and refill dates) for a brine tank may be generated (e.g., to provide historical perspective). Such a report may be useful in helping understand the effect of salt height in the tank on consumption.

Referring again to FIG. 39, in various embodiments, in step S2040, a route plan is communicated from the fleet management server to vehicle management computer. In various embodiments, the vehicle may be guided on an optimized or preferred delivery route which can be determined using information such as customer tank fill needs (or anticipated needs), customer location, special customer instructions or information, truck hopper capacity or load level (e.g., on a particular day or at a particular time), and/or truck location. In various embodiments, the fleet management server may use such information or factors to set routes for customers needing a refill or nearby customers close to needing a refill. Such an optimized or preferred delivery route can help reduce overall delivery cost.

For example, combining known or measured salt levels (by monitoring the need for a refill of the tank within a “fill range”) with route optimization may reduce overall costs. For example, if a brine tank is optimally refilled at 33% full of salt (67% empty), then a predefined fill-range of perhaps 30-40% full may be used to trigger or mark a refill candidate. If customer A is within a given distance (e.g., 0.5 miles) of customer B, and customer A's tank is at 33% full, and customer B's tank is at 40% full, the two could be marked or triggered to be filled as part of the same delivery route. By filling both customer A and customer B on a single route or trip, the travel and fuel cost to fill both tanks is reduced overall. In summary, if a given tank is geographically nearby another which needs to be refilled, that additional factor can be added to the optimization to determine if the cost could be lowered by filling that tank.

As another example, if the capacity of a hopper is 8,000 lbs., for example, and the customer A is a commercial customer needing 600 lbs. of salt, and customer B is a residential customer needing 150 lbs. of salt (near the end of the route), it may be preferable to service customer B if the hopper is expected to have less than 600 lbs. of salt remaining in the hopper at that point in the route. This is known in mathematics as an NP complete Integer-Linear programming problem in the classification as either a “knapsack problem” with a single truck or bin-packing problem with a plurality of trucks. Applying an algorithm may reduce the overall cost of delivery versus simply factoring in route optimization.

Referring now to FIG. 44, a method or system for delivery determination and prediction 1310 is illustrated according to various examples of embodiments. In various embodiments, method for delivery determination and prediction 1310 helps manage the scheduling of deliveries. In method 1310, a number of factors may be used in determining when to schedule a customer tank refill including, without limitation, customer compliance to payment terms 1320, or other factors such as measured or determined tank salt level, salt consumption history and/or forecast, and route optimization 1330 (e.g., relative distance to others also needing salt delivered).

In various embodiments, the relationship between a delivery agent and a route plan is optimized based at least in part on tracking information on actual deliveries. In various embodiments, such tracking allows for that correlation in provides a feedback loop to the delivery plan indicating how much time it typically takes to deliver to a given customer.

In various embodiments, a delivery vehicle or truck computer connects via a cellular network to a cloud server, which stores GPS data, in combination with vehicle stops near a customer. In various embodiments the delivery vehicle or truck computer tracks time at a customer site, combined with time of turning on delivery system (start of salt delivery) as well as travel between customers, which allows for performance measuring, and/or reporting predictive modeling. For example, time on site may track or measure setup time (e.g., time from stop until start of salt delivery), time of actual salt delivery (e.g., a measure of performance of the truck-based pump or blower system to move salt) and tear-down time (e.g., a time from the stop of salt delivery to the time the truck is moving again (e.g., on to the next delivery or return to base)).

Once loaded, the vehicle is sent out for one or more deliveries (e.g., along a predetermined delivery route). For example, in step S2050, the salt delivery system may be transported to a residential or commercial building having a saltwater softening system and brine tank or salt bin on the premises. In various embodiments, after arrival at a refill site and positioned in an appropriate area, the vehicle may be placed into park, the parking brake engaged, and any hazard or other indicator lights may be activated. The salt delivery system may be activated, for example, by hitting a button or switch (e.g., a “Power Take Off” or PTO button on the console of the vehicle). In various embodiments, the weight of hopper (or salt in hopper) is measured and recorded. Upon activation of the delivery system, the engine is set to approximately 1600 RPMs, and the weighing system or scale raised or otherwise moved into a “level” position.

A delivery agent may then put on ear and/or eye protection, exit the vehicle, position safety cones or other indicators on the driver's left side of vehicle, and take one end of the salt delivery hose to an appropriate fill port.

A delivery agent may locate and/or identify the appropriate fill port in a number of ways. For example, the fill port may have a unique identification number or code relative to the others that is manually (or electronically, such as with a barcode) identified by the agent. A delivery agent may have a hard copy report, or electronic report in a portable or mobile electronic computer (e.g., the handheld) from a central server fed with data from network-attached tank monitoring computer on every tank to be filled, containing the delivery sequence or delivery plan by unique port number. In various embodiments, the fill ports are filled or otherwise addressed in a predetermined sequence according to a predetermined or other delivery plan.

In various embodiments, the delivery plan is generated at the central server to efficiently route the vehicle and delivery agent to those containers and fill ports needing a refill. In addition, in various embodiments, the delivery agent has access to an electronic handheld device to display the fill port sequence by unique identifier. The portable handheld device is also enabled with a GPS sensor and tracking application to allow the delivery agent to find a GPS-tagged fill port efficiently in the predetermined sequence. A map display shown on the handheld may be utilized in locating the fill port location on the building and may also show the delivery agent's current position relative to the port to assist in efficiently locating the correct port.

To avoid needing a handheld device, reduce opportunity for human error, and/or allow for a change in delivery plan (e.g., due to unforeseen circumstances), in various embodiments, in step S2060, one or more indicators are provided near the fill port and connected to the network interface module (NIM) monitoring the tank level via the cloud server, and communicating with the cloud server in substantially real time via a network indicating which fill port is next in the predetermined sequence to be filled. In various embodiments, a latch is built into the fill port coupling with wires closing a switch (e.g., a magnetic reed switch) where the indicator turns (e.g., from a flashing red light) to another indicator (e.g., a solid green light) once a delivery hose attachment is secured in a locked position relative to the fill port.

As another example, the agent may scan the barcode of the fill port (e.g., with the mobile device with a scanner or scanning apparatus), which may automatically load the customer ID and tank number into the in-vehicle weighing computer (e.g., a Rice Lake brand 920 and/or 1280 onboard weighing system), and may send the customer identification information (e.g., name, number, etc.) and in step S2070, send fill amount or stop limit from the vehicle management computer to the vehicle weighing scale computer. Information such as the customer identification information (e.g., name, number, etc.) and/or fill amount or stop limit associated with the bar code may also be communicated to the mobile device on the delivery agent.

In various embodiments, each fill port has a barcode associated with it, and the handheld device includes a barcode reader or reader application, and a “go” button on the handheld device. In addition, in various embodiments, the vehicle management computer is enabled with Wi-Fi wireless communication (Wi-Fi access point—AP) connected, acting as a router to the cellular Internet or network. In various embodiments, the handheld device is Wi-Fi enabled, and the network interface module (NIM) is Wi-Fi enabled as connected through the W-Fi-enabled vehicle management computer. This allows the vehicle management computer to communicate directly with the handheld device and directly with the network interface module (NIM), and also allows indirect communication between the handheld device and the network interface module (NIM) via the Wi-Fi AP in the vehicle. In addition, the Wi-Fi network may be used as a backup to the cellular network connection of the vehicle management computer, handheld device and the network interface module (NIM).

In various embodiments, the delivery agent finds the fill port using the GPS and the electronic mapping on the handheld, reads the associated or nearby barcode using the handheld device, which sends a signal to the vehicle management computer indicating the unique tank or port to be filled, which contains a database or delivery plan in the vehicle management computer, and automatically reprograms the vehicle weighing system computer over the Wi-Fi network to set the correct customer identifier and fill amount for the fill port associated with the barcode. In various embodiments, once the delivery hose is latched and locked (via a signal via the magnetic reed switch) of the network interface module (NIM) sends a signal back to the portable handheld indicating that the delivery hose is now attached and latched to the correct fill port, which enables the app “go” button on the handheld device, allowing the delivery agent to press or activate the “go” button to start a fill process.

In various examples of embodiments, a fill port includes an RFID (radio frequency identification) or NFC (near field communication) chip or tag which may be read with an RFID or NFC reader mounted in or on the delivery hose connection (on the delivery hose side). In various examples of embodiments, the RFID unique identifier associated with a fill port is correlated to the customer tank in the server database allowing the unique identifier to be included in the delivery plan. This allows the NFC reader connected to the delivery vehicle management computer (either by wireless or wired connection) to select the correct customer tank to be selected from the delivery plan by the vehicle management computer, setting the correct customer ID and product in the vehicle weighing system computer automatically when the delivery hose is connected to the fill port on the building. In various embodiments, a switch in the delivery hose which closes at the final “lock” state can provide a positive lock, to help ensure the RFID tag isn't read until the hose is locked in place to the fill port. In various examples of embodiments, locking or connecting the hose to the fill port can automatically start the delivery system (making activation on the remote control or handheld now optional (e.g., for safety purposes). This also helps prevent overfilling (or under-filling) brine tanks outside the delivery plan as there is a real-time verification lookup of the tank level queried by the vehicle management computer through the server to the network interface module (NIM) reading server tank level data and information in real time. The RFID identification allows for out-of-sequence filling, and should prevent the wrong tank from being filled, or a tank being filled with an incorrect amount. RFID identification also reduces the need for a handheld computer.

Once the fill port unique ID is located, in various embodiments, the delivery agent clamps on the delivery hose to the appropriate port, and a signal is provided (e.g., from the handheld or the RFID through the server) to the vehicle weighing system computer, to start the fill process. In various embodiments, the delivery agent may use the remote control to start the auger, blower, and rotary valve. In various embodiments, the fill process is stopped (e.g., automatically) by the vehicle weighing system computer when the predetermined fill weight is reached.

In various embodiments, the system allows a manual override of the sequence where each fill port has a pushbutton override switch or button on the network interface module (NIM) allowing the delivery agent to activate it to indicated that they wish to fill a tank or connect to a fill port out of scheduled order. Activation of switch or button may communicate a signal from the network interface module (NIM) to the server to indicate the desire to fill out of order, and include the unique identifier of the fill port to be filled out of order, so that the server can then determine whether the requested fill port actually needs to be filled. If it determines that the requested fill port needs to be filled, the server communicates to the network interface module (NIM) to activate a flashing red light indicating it is okay to begin connecting this out-of-order fill port. The delivery agent attaching and locking the hose; the system (before the green light is lit) has automatically reprogrammed the vehicle weighing computer (from the server) to set the correct customer ID and limit set point of that out-of-order fill port.

After locating the appropriate fill port and unlocking and/or removing the fill port cap, coupling the hose to the fill port, and checking the vicinity of the vehicle to help ensure it is safe to proceed, the fluid moving apparatus may be started. Once the fluid moving apparatus has reached an appropriate speed (e.g., in approximately ten seconds), the rotary valve may be started (e.g., by the agent using the remote control). Once the rotary valve is moving at an appropriate speed (e.g., in approximately three seconds), the auger may then be started (e.g., by the agent using the remote control) and salt is moved from the hopper on the vehicle into the on-site system.

To help prevent salt from clogging the salt delivery system and/or the on-site system, in various embodiments, the amount of salt provided into the tank fill tube is controlled (e.g., by the auger and/or rotary speeds) to prevent it from exceeding the capacity of the airflow system to help consume and drive the salt (e.g., using airborne delivery) to the brine tank. In various embodiments, the pressure sensor provided near the exit point of the fill tube can be used to measure the air pressure in the system at that point and, using that air pressure reading, the amount of salt that can be consumed by the fill tube can be determined and controlled to prevent clogging.

By using measured air pressure (which can be influenced by one or more of the following alone or in combination: fan speed, altitude, moisture, temperature, humidity), the blower fan speed, auger (moves salt from the hopper in the truck to the rotary) speed, and rotary RPMs can all be adjusted or optimized to prevent clogging. For example, by monitoring the pressure at the fill port, the blower speed can be adjusted for the distance the salt needs to be blown or otherwise needs to travel. This may also help conserve energy and power at the blower, while ensuring the system has sufficient pressure to push or provide the salt to an exit point inside the tank. The auger speed and rotary speed may also be adjusted to the determined or measured salt delivery speed or blower speed, as the blower force likely needs to exceed the force needed to make the salt airborne.

In various embodiments, in step S2080, the sensor data server sets the network interface module into a fill state (i.e., a fill process where salt is provided into the brine tank). The fill state may also occur when the start process occurs on the in-vehicle weighing system via the vehicle system. In various embodiments, in step S2090, while salt is being provided into the brine tank, the tank sensors communicate constant, frequent or periodic depth updates to the network interface module, and the network interface module (NIM) fires constant, frequent or periodic tank depth data updates to the sensor data server.

In various embodiments, in step S2110, constant, frequent or periodic tank depth data updates are also communicated from the sensor data server to the vehicle scale computer. In step S2120, real-time monitoring of the fill process may also be used, allowing the delivery agent to monitor and know how far from full the brine tank is during the fill process. In various embodiments, filling continues until the stop limit is reached, at which time in step S2130, vehicle weighing scale computer communicates to the vehicle management computer that the stop limit has been reached, and the vehicle management computer triggers the auger to shut down. After it is communicated to the vehicle management computer that the stop limit has been reached, in various embodiments, it is communicated to the sensor data server that the fill has been stopped, and in step S2150, the sensor data server sets the network interface module (NIM) to return to the idle state, and the network interface module (NIM) stops transmitting depth updates in this state.

The rotary and blower may also shut down after some predetermined amount of time (e.g., 30 seconds or some other time, based on timers controlling relays) or as controlled by the agent (e.g., using the remote control or manually) following the shutdown of the auger. In various embodiments, the weight of the hopper (or salt in the hopper) is measured and recorded. In various embodiments, in step S2160 performance metrics from the delivery are communicated from the vehicle management computer to the fleet management server. In various embodiments, in step S2170, refill metrics are communicated from the fleet management server to the customer management server.

In the embodiments having one or more indicators, once the delivery to a brine tank is complete (e.g., a signal from the vehicle weighing system via the vehicle management system, to the server indicates that the fill point (limit set point) was reached and the fill was stopped), the server then sends a signal to the network interface module (NIM) computer to dim the green light associated with the current fill port and to start flashing the red light on the next scheduled fill port.

The agent may then disconnect the delivery hose from the fill port, cover the fill port with its cover or cap, store the hose on the vehicle, and collect and stow the safety cones or indicators. The agent may then press the PTO to reduce the engine RPMs, lower the scale, and shut down the blower if it is not already shutdown.

In various embodiments, the system generates and/or allows an invoice to be generated for a given customer immediately or soon after the delivery. In various embodiments, the invoice is generated based on the amount (e.g., poundage) of salt actually delivered and not on the sensor reading itself. In various embodiments, a computer on the delivery vehicle or truck connects via cellular network to a cloud-based sales platform (or cached on the vehicle computer for later batch upload) where upon culmination of a delivery, the delivery agent may physically enter the exact delivered poundage into a browser-based digital form visualized on an onboard tablet device. This form may then be associated with that particular customer which may, in turn, trigger an invoicing system that is executed on the customer file, either emailing an invoice to a commercial account billing contact, or in the case of a residential account, charging that account. In various embodiments, the need for the delivery agent to physically enter delivered poundage may be lessened or eliminated and the actual poundage delivered may communicated directly from a weighing system (e.g., on the truck or at the tank), and the agent may simply confirm the communicated weight (e.g., by pressing a confirmation button which will be sufficient to start automated invoicing processes.

From there, the agent may disengage the parking brake, turn off the flashers or other indicator lights, and then move the vehicle to the next stop.

It is known that, during a regeneration cycle of resin beads in a mineral tank via salt brine drawn from a brine tank, a considerable amount of water is used to flush out salt brine discharge once the resin beads have been recharged. This salt brine discharge is commonly flushed into a main drain for eventual treatment at a waste-water treatment center. This high salt saturation effluent with high levels of TDS (total dissolved solids) has a measurably detrimental effect on a recycle treatment process. In fact, due to the complexities and rising costs associated with desalination of salt brine discharge, several counties in various states across the United States (especially California) have banned the use of self-regenerating water softeners for this reason alone.

In various embodiments, data gathered by the salt monitoring and delivery system may be utilized to help reduce salt brine discharge and salt waste. For example, the data may be useful in optimizing water softener use and/or salt use to reduce the amount of such discharge. As another example, the data may help customers to optimize their specific water softener for their specific water condition. For example, providing consumers with data or recommendations based on their salt consumption compared to that of others (such as, for example, others with similar water softener models, water conditions, season, number of occupants, etc.) may help those customers to optimize the operation of their water softener. As another related example, the data may help manufacturers optimize their water softeners for specific water conditions, geography, season, occupancy, etc.

In various embodiments, calcium chloride or brine water may also be collected for reclamation (e.g., by collecting salt brine discharge in a separate container and pulling the discharge (e.g., by a vacuum-powered system) for transport or later transport to a facility where the salt brine could be stored for reuse, or the salt could be separated from the brine water and re-used. Depending on the geographical need, the salt brine itself may be used for other purposes such as pre-icing or de-icing activities in the colder climates.

It should be appreciated that the disclosed system, apparatus and/or method for remote delivery of salt may also be utilized for the remote delivery of other products in other industries. For example, it may be utilized in the grain or agricultural industry, CO2 industry for medical lab and restaurant industries, dry product industries, dog food delivery industry, cat litter delivery industry, non-hazardous chemical industry, laundry detergent industry, and/or filtered water (drinking water).

The disclosed system may also be adapted to serve other systems in a home or business. (For example, it may be adapted into or utilized in a “Smart Home System” that, for example, uses 3G capacity to manage HVAC, floor heat, fireplaces, lighting, security and other systems. Integration of the disclosed system may be integrated into a management system that would provide a benefit to the residential and business owner.

It should also be noted that a lidar radar sensor reflecting off liquid may be utilized in other parts of a home or business. For example, it may be utilized for filling cups of soda or water to a predetermined height dispensed by an automatic filling machine. For example, using a combination of a first or top lidar sensor (to measure the depth of the water) and an array of lidar sensors to determine the cup height, and communicating sensor information to a processor, the cup height and water height may both be determined. For example, while filling, a vertical-spaced array (e.g., spaced every one-half inch, and perhaps more tightly at the “typical” cup height of a cup), lidar sensors reflecting off either the cup or the standard-sized opening of the water dispenser may provide the processor the necessary measurements of the cup height and content depth, and may be used to shut off the feed of liquid at a certain depth (e.g., one-half inch below the cup height).

As indicated, in one or more examples of embodiments, the system and/or method may be implemented by a microcontroller, a computer system, or in combination with a computer system. The computer system may be or include a processor. The computers may be electronic devices for use with the methods and various components described herein and may be programmable computers which may be special purpose computers or general purpose computers that execute the system according to the relevant instructions. The computer system or portable electronic device can be an embedded system, a personal computer, notebook computer, server computer, mainframe, networked computer, workstation, handheld computer, as well as now known or future developed mobile devices, such as for example, a personal digital assistant, cell phone, smartphone, tablet computer, and the like. Other computer system configurations are also contemplated for use with the communication system including, but not limited to, multiprocessor systems, microprocessor-based or programmable electronics, network personal computers, minicomputers, smart watches, and the like. Preferably, the computing system chosen includes a processor suitable in size to efficiently operate one or more of the various systems or functions or attributes of the communication system described.

The system or portions thereof may also be linked to a distributed computing environment, where tasks are performed by remote processing devices that are linked through a communication network(s). To this end, the system may be configured or linked to multiple computers in a network including, but not limited to, a local area network, wide area network, wireless network, and the Internet. Therefore, information, content, and data may be transferred within the network or system by wireless means, by hardwire connection, or combinations thereof. Accordingly, the servers described herein communicate according to now known or future developed pathways including, but not limited to, wired, wireless, and fiber-optic channels.

Data, for example, sensor data or recommendations, may be sent or submitted via the Internet, wireless, and fiber-optic communication network(s), or created or stored on a particular device. In one or more examples of embodiments, data may be stored remotely or may be stored locally on the user's device or controller. In one example, data may be stored locally in files. Data may be stored and transmitted by and within the system in any suitable form. Any source code or other language suitable for accomplishing the desired functions described herein may be acceptable for use.

Furthermore, the computer or computers or portable electronic devices may be operatively or functionally connected to one or more mass storage devices, such as but not limited to, a database. The memory storage can be volatile or non-volatile, and can include removable storage media. Cloud-based storage may also be acceptable. The system may also include computer-readable media, which may include any computer-readable media or medium that may be used to carry or store desired program code that may be accessed by a computer. The invention can also be embodied as computer-readable code on a computer-readable medium. To this end, the computer-readable medium may be any data storage device that can store data which can be thereafter read by a computer system. Examples of computer-readable medium include read-only memory, random-access memory, CD-ROM, CD-R, CD-RW, magnetic tapes, flash drives, as well as other optical data storage devices. The computer-readable medium can also be distributed over a network-coupled computer system so that the computer-readable code is stored and executed in a distributed fashion.

As indicated, a display (not shown) may be provided for display of data. To this end, a screen may be provided as part of the system. The screen may be a tablet or mobile computing device. The screen may transmit or receive data over Wi-Fi or Bluetooth. The screen may be positioned where a user may observe the screen data.

Additionally, information may be stored in the system such that data can be used to provide feedback. In various embodiments, data may be stored in the screen, computing device, mobile device, or other suitable location.

Communication by or between the microcontroller or computing device and various receiving entities described could be made possible by use of Wi-Fi, Bluetooth, or other suitable transmission mechanism.

The system may include a display provided on a user feedback screen (not shown). After the data is sensed, the data (which may be stored data) or any analytical results may be displayed by the microcontroller on the screen, or alternatively or additionally on an application, such as a tablet, mobile device, or phone application. The display may show data results, as well as feedback for the user based on the data. Sending the result to a physician may be optional to the user either via email or personal electronic file.

According to the foregoing algorithms, the system automatically monitors brine tank salt levels. Some portions of the detailed descriptions herein are presented in terms of procedures, steps, logic blocks, processing, and other symbolic representations of operations on data bits that can be performed on computer memory. These descriptions and representations are the means used by those skilled in the data-processing arts to most effectively convey the substance of their work to others skilled in the art. A procedure, computer-executed step, logic block, process, etc. is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It should be borne in mind; however, that all of these and similar terms are to be associated with the appropriate physical quantities and are merely convenient labels applied to these quantities. Unless specifically stated otherwise as apparent from the discussions herein, it is appreciated that throughout the present invention, discussions utilizing terms, such as “communicating,” “receiving,” “sending,” “generating,” “reading,” “invoking,” “selecting,” and the like, refer to the action and processes of a computer system, or similar electronic computing device, including an embedded system, that manipulates and transforms data represented as physical (electronic) quantities within a suitable computer system.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied (e.g., by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier-developed alternatives, modifications, variations, improvements and/or substantial equivalents.

The technical effects and technical problems in the specification are exemplary and are not limiting. It should be noted that the embodiments described in the specification may have other technical effects and can solve other technical problems.

What is claimed is:

1. A salt delivery system comprising:
a mixing tube in fluid communication with an outlet of a fluid moving apparatus;
a salt source in operative communication with the mixing tube;
a delivery hose in fluid communication with the mixing tube and a fill port on a structure;
a first conduit in fluid communication with the fill port and an inlet of a brine tank;
a second conduit in fluid communication with a return outlet of the brine tank and a return port on the structure; and
a return hose in fluid communication with the return port and an inlet of the fluid moving apparatus.

2. The salt delivery system of claim 1, whereby the fluid moving apparatus is configured to provide air pressure to move salt from the mixing tube to the brine tank while introducing a negative pressure bias within the brine tank.

3. The salt delivery system of claim 1, whereby the fluid moving apparatus is a positive displacement pump.

4. The salt delivery system of claim 3, whereby the positive displacement pump is configured to introduce salt from the mixing tube to the brine tank while introducing a negative pressure bias within the brine tank.

5. The salt delivery system of claim 1, whereby a rotary airlock valve is provided between the salt source and the mixing tube to introduce salt into the mixing tube.

6. The salt delivery system of claim 5, whereby the rotary airlock valve is configured to permit the passage of salt to the mixing tube while minimizing a change of pressure in the mixing tube or loss of pressure from it.

7. The salt delivery system of claim 1, whereby the inlet of the brine tank and return outlet of the brine tank are provided on a lid to the brine tank.

8. The salt delivery system of claim 2, whereby a sensor housing including a sensor for helping measure a salt level in the brine tank is coupled to the brine tank.

9. The salt delivery system of claim 8, whereby the sensor housing defines one or more ports or apertures to allow air into the brine tank when there is a negative pressure bias within the brine tank.

10. The salt delivery system of claim 9, whereby the ports or apertures are configured to direct air toward the sensor to prevent salt from negatively impacting the sensor's ability to help measure the salt level in the brine tank.

11. A salt delivery system comprising a substantially closed loop extending from an outlet of a fluid moving apparatus to an inlet of a brine tank and from an outlet of a brine tank back to an inlet of the fluid moving apparatus.

12. The salt delivery system of claim 11, further comprising a rotary airlock valve configured to introduce salt into the closed system between the outlet of the fluid moving apparatus and the inlet of the brine tank while minimizing the change of pressure in the closed system or loss of pressure between fluid moving apparatus and the inlet of the brine tank.

13. The salt delivery system of claim 11, whereby the fluid moving apparatus is configured to provide positive pressure between the outlet of the fluid moving apparatus and the inlet of the brine tank and a nominal or negative pressure or bias in the brine tank while providing salt into the brine tank.

14. The salt delivery system of claim 13, whereby the brine tank defines one or more air inlets to help allow relief from any negative pressure or bias provided in the tank.

15. The salt delivery system of claim 14, whereby a sensor housing including a sensor for helping measure a salt level in the brine tank is coupled to the brine tank.

16. The salt delivery system of claim 15, whereby the sensor housing defines one or more ports or apertures to allow air into the brine tank when there is a negative pressure bias within the brine tank.

17. The salt delivery system of claim 16, whereby the ports or apertures are configured to direct air toward the sensor to prevent salt from negatively impacting the sensor's ability to help measure the salt level in the brine tank.

18. A method for delivering salt into a brine tank, the method comprising:
transporting a vehicle having a salt source, a rotary valve, and a fluid moving apparatus having an outlet and an inlet, to a location near a structure housing a brine tank, the brine tank having an inlet fluidly connected to a fill port on the structure and an outlet fluidly connected to a return port on the structure;
fluidly coupling the outlet of the fluid moving apparatus to the fill port using a delivery conduit;
fluidly coupling the inlet of the fluid moving apparatus to the return port using a return conduit;
rotating the rotary valve to introduce salt from the salt source into the delivery conduit;
operating the fluid moving apparatus to create positive pressure to move salt through the delivery conduit and the fill port and into the brine tank while simultaneously creating a nominal or negative pressure in the brine tank and return conduit.

19. The method for delivering salt into a brine tank of claim 18, whereby the vehicle also includes an auger extending from the salt source and the auger is rotated to introduce a predetermined amount of salt from the salt source to the rotary valve.
